(19) United States
(12) Patent Application Publication
(10) Pub. No.: US 2025/0278179 A1
(43) Pub. Date: Sep. 4, 2025

(54) INFORMATION SELECTION IN TABLE WITH GENERATED WINDOW

(71) Applicant: SAP SE, Walldorf (DE)

(72) Inventors: Lisa Voshage, Reilingen (DE); Jens Pflueger, Karlsruhe (DE); Colin Doherty, Limerick (IE)

(21) Appl. No.: 18/591,207

(22) Filed: Feb. 29, 2024

(51) Int. Cl. G06F 3/04842; G06F 3/04812; G06F 3/0486

(52) U.S. Cl. CPC G06F 3/04842; G06F 3/04812; G06F 3/0486

(57) ABSTRACT

A machine is configured to access a table that includes cells arranged in columns and rows. The machine then displays a first cell of the table. The displayed first cell is in a row that includes a second cell in a column that is not displayed. The machine generates and displays a window adjacent to the displayed first cell and showing data from the second cell not displayed. The machine then detects a selection input that has a selection endpoint and defines a selection of information. The machine, based on the selection endpoint of the selection input being within the window displayed adjacent to the first cell, then indicates that the data from the second cell and shown in the generated window is included in the selection of information defined by the detected selection input.

### TECHNICAL FIELD

The subject matter disclosed herein generally relates to the technical field of special-purpose machines that facilitate interactions with data in tables, including software-configured computerized variants of such special-purpose machines and improvements to such variants, and to the technologies by which such special-purpose machines become improved compared to other special-purpose machines that facilitate interactions with data in tables. Specifically, the present disclosure addresses systems and methods to facilitate information selection in a displayed table where the on-screen display area seen by a human user is relatively smaller than the amount of data stored in the table. In such a scenario, at least some of the data that is off-screen can be presented in a generated window, and the human user's ability to select the data presented in the generated window is allowed.

### BACKGROUND

A machine may be configured to interact with one or more users by presenting all or part of a table in which data is stored and organized in multiple cells. The cells of the table may each contain a separate corresponding value, and the cells of the table may be arranged as multiple columns of cells and multiple rows of cells. In some cases, a table may contain hundreds or thousands of rows, columns, or both. In many user devices, such as desktop computers, laptop computers, notebook computers, and mobile devices (e.g., smart phones), the available screen size on such devices is insufficient to display all of the rows or columns of the table at one time. When this occurs, the user typically scrolls left and right to bring additional columns into view on the display, while simultaneously scrolling other, currently visible columns off of the screen, and up and down to bring additional rows into view on the display, while simultaneously scrolling other, currently visible rows off of the screen.

In these scenarios where the number of rows or columns that can be legibly displayed on a screen is far fewer (e.g., 5 to 25) than the total number of rows or columns in a data table (e.g., hundreds), it can be difficult for the user to scroll left and right and up and down to both see all of the data and select portions of the data for extraction, copying and further processing. In addition, the ability to select a plurality of rows or columns for further processing, but not necessarily the entire data table, can be challenging as a user may have to use the scrolling function(s) to select the appropriate sets of rows and columns from the data table.

### BRIEF DESCRIPTION OF THE DRAWINGS

The patent or application file contains at least one drawing executed in color. Copies of this patent or patent application publication with color drawings will be provided by the U.S. Patent and Trademark Office upon request and payment of the necessary fee.

Some embodiments are illustrated by way of example and not limitation in the figures of the accompanying drawings.

FIG. 1 is a network diagram illustrating a network environment suitable for information selection in a table displayed with a generated window, according to some example embodiments.

FIG. 2 is a block diagram illustrating components of a machine

suitable for information selection in a table displayed with a generated window, according to some example embodiments.

FIG. 3 is a block diagram illustrating components of a device suitable for information selection in a table displayed with a generated window, according to some example embodiments.

FIGS. 4-6 are flowcharts illustrating operations in performing a method of information selection in a table displayed with a generated window, according to some example embodiments.

FIG. 7 is a user-interface diagram illustrating a user interface displaying some cells of a table and displaying some generated windows, each generated window showing data from one or more non-shown cells of the table, according to some example embodiments.

FIGS. 8-11 are user-interface screenshots illustrating selection of information across rows of a table by using a cursor drag input (e.g., dragging a mouse pointer) that moves from left to right, according to some example embodiments.

FIGS. 12-16 are user-interface screenshots illustrating selection of information across rows of a table by using a cursor drag input that moves from right to left, according to some example embodiments.

FIGS. 17-19 are user-interface screenshots illustrating selection of information by using a cursor drag input that starts (e.g., initiates) inside a generated window, according to some example embodiments.

FIGS. 20-24 are user-interface screenshots illustrating selection of information by using a cursor drag input that stops (e.g., terminates) inside a generated window, according to some example embodiments.

FIGS. 25-27 are user-interface screenshots illustrating selection of information by using a keyboard input that selects down and right, according to some example embodiments.

FIGS. 28-30 are user-interface screenshots illustrating selection of information by using a keyboard input that selects down and left, according to some example embodiments.

FIGS. 31-33 are user-interface screenshots illustrating selection of information by using a keyboard input that starts on a generated window, according to some example embodiments.

FIG. 34 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) facilitate information selection in a table, at least a portion (e.g., at least one cell) of which is displayed with a generated window, and example systems (e.g., special-purpose machines configured by special-purpose software) are configured to facilitate information selection in a table, at least a portion of which is displayed with a generated window. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

A machine is configured (e.g., by suitable software, hardware, or combination of both) to access a table that includes cells arranged in columns and rows. The machine then displays (e.g., within a user interface, such as a graphical user interface) a first cell of the table (e.g., as part of displaying a portion of the table). The displayed first cell is in a row that includes a second cell in a column that is not displayed (e.g., a column that is hidden, off-screen, cropped, truncated, or otherwise omitted from view). The machine generates and displays a window (e.g., a temporary window that is not a cell of the table) adjacent to the displayed first cell and showing data from the second cell, but the second cell itself is not being displayed. The machine then detects (e.g., receives) a selection input that has a selection endpoint and defines a selection of information. The machine, based on the selection endpoint of the selection input being within the window displayed adjacent to the first cell, then indicates (e.g., visually, within the user interface) that the data from the second cell and shown in the generated window is included in the selection of information defined by the detected selection input. Further details are discussed below.

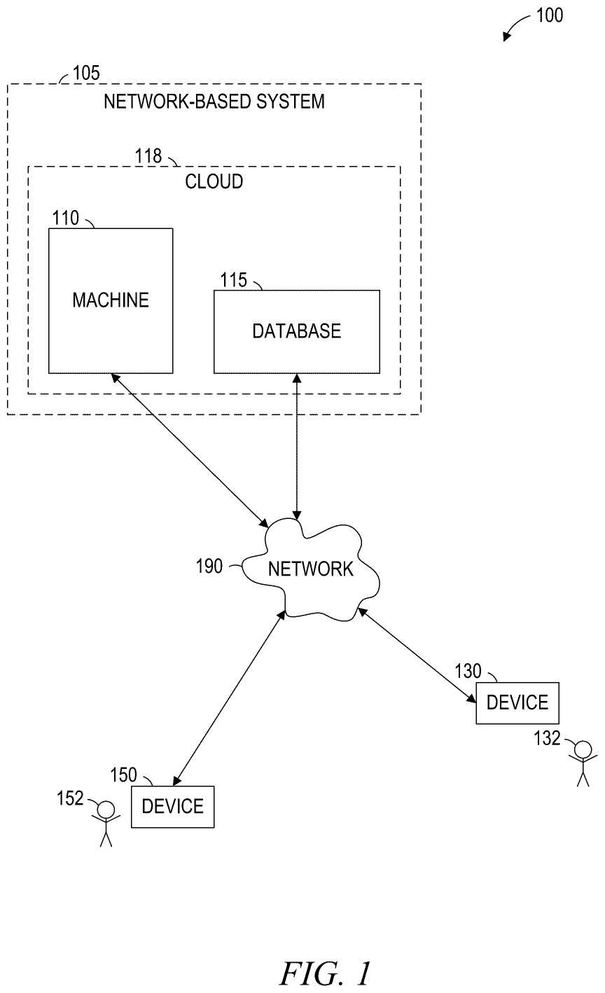

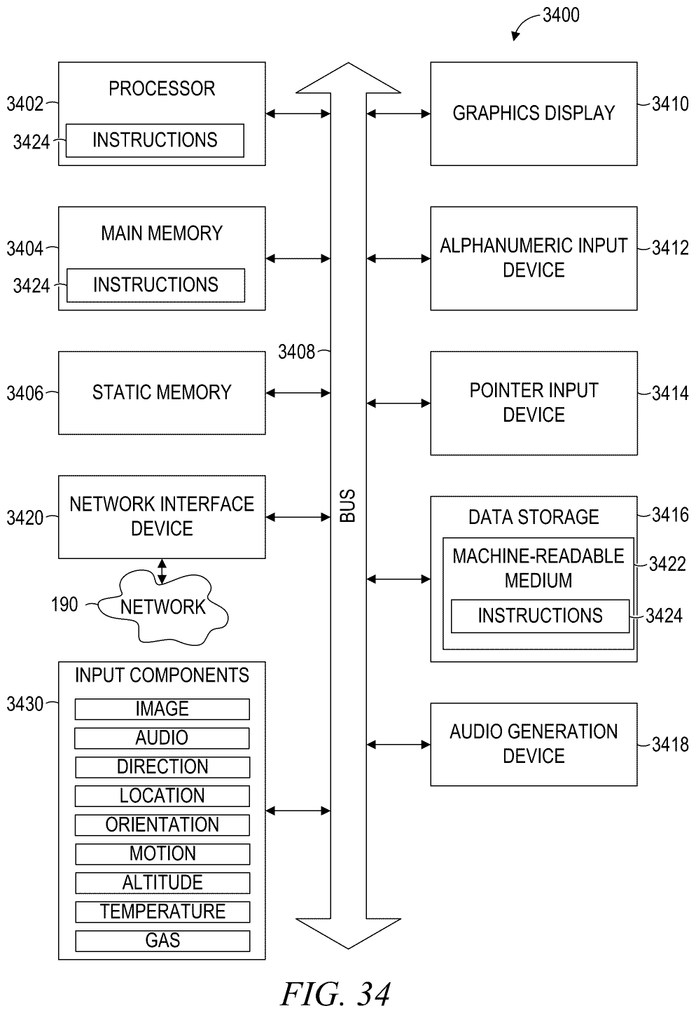

FIG. 1 is a network diagram illustrating a network environment suitable for information selection in a table displayed with a generated window, according to some example embodiments. The network environment 100 includes a machine 110 (e.g., a server machine), a database 115, and devices 130 and 150 (e.g., client devices), all communicatively coupled to each other via a network 190. The machine 110, with or without the database 115, may form all or part of a cloud 118 (e.g., a geographically distributed set of multiple machines configured to function as a single server), which may form all or part of a network-based system 105 (e.g., a cloud-based server system configured to provide one or more network-based services to the devices 130 and 150). The machine 110 and the devices 130 and 150 may each be implemented in a special-purpose (e.g., specialized) computer system, in whole or in part, as described below with respect to FIG. 34.

Also shown in FIG. 1 are users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is associated with the device 130 and may be a user of the device 130. For example, the device 130 may be a desktop computer, a vehicle computer, a home media system (e.g., a home theater system or other home entertainment system), a tablet computer, a navigational device, a portable media device, a smart phone, or a wearable device (e.g., a smart watch, smart glasses, smart clothing, or smart jewelry) belonging to the user 132. Likewise, the user 152 is associated with the device 150 and may be a user of the device 150. As an example, the device 150 may be a desktop computer, a vehicle computer, a home media system (e.g., a home theater system or other home entertainment system), a tablet computer, a navigational device, a portable media device, a smart phone, or a wearable device (e.g., a smart watch, smart glasses, smart clothing, or smart jewelry) belonging to the user 152.

Any of the systems or machines (e.g., databases and devices) shown in FIG. 1 may be, include, or otherwise be implemented in a special-purpose (e.g., specialized or otherwise non-conventional and non-generic) computer that has been modified to perform one or more of the functions described herein for that system or machine (e.g., configured or programmed by special-purpose software, such as one or more software modules of a special-purpose application, operating system, firmware, middleware, or other software program). For example, a special-purpose computer system able to implement any one or more of the methodologies described herein is discussed below with respect to FIG. 34, and such a special-purpose computer may accordingly be a means for performing any one or more of the methodologies discussed herein. Within the technical field of such special-purpose computers, a special-purpose computer that has been specially modified (e.g., configured by special-purpose software) by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured in any of various ways, for example, as a text file, a table, a spreadsheet, a relational database (e.g., an object-relational database), a triple store, a hierarchical data store, a document database, a graph database, key-value pairs, or any suitable combination thereof. Moreover, any two or more of the systems or machines illustrated in FIG. 1 may be combined into a single system or machine, and the functions described herein for any single system or machine may be subdivided among multiple systems or machines.

The network 190 may be any network that enables communication between or among systems, machines, databases, and devices (e.g., between the machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone service (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

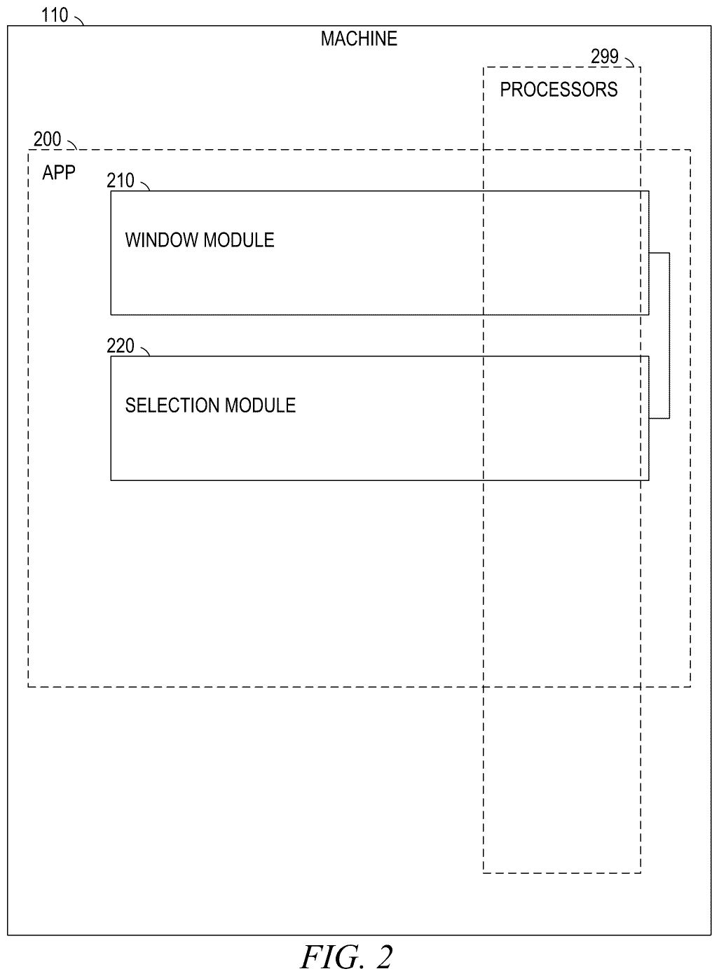

FIG. 2 is a block diagram illustrating components of the machine 110, configured for information selection in a table displayed with a generated window, according to some example embodiments. The machine 110 is shown as including a window module 210 (e.g., a window generation module or suitable code to generate a window, as described herein) and a selection module 220 (e.g., an information selection module or suitable code to select information), which are configured to communicate with each other (e.g., via a bus, shared memory, or a switch).

As shown in FIG. 2, the window module 210 and the selection module 220 may form all or part of an app 200 (e.g., a mobile app) that is stored (e.g., installed) on the machine 110 (e.g., responsive to or otherwise as a result of data being received via the network 190, such as from the database 115 or from the device 130). Furthermore, one or more processors 299 (e.g., hardware processors, digital processors, or any suitable combination thereof) may be included (e.g., temporarily or permanently) in the app 200, the window module 210, the selection module 220, or any suitable combination thereof.

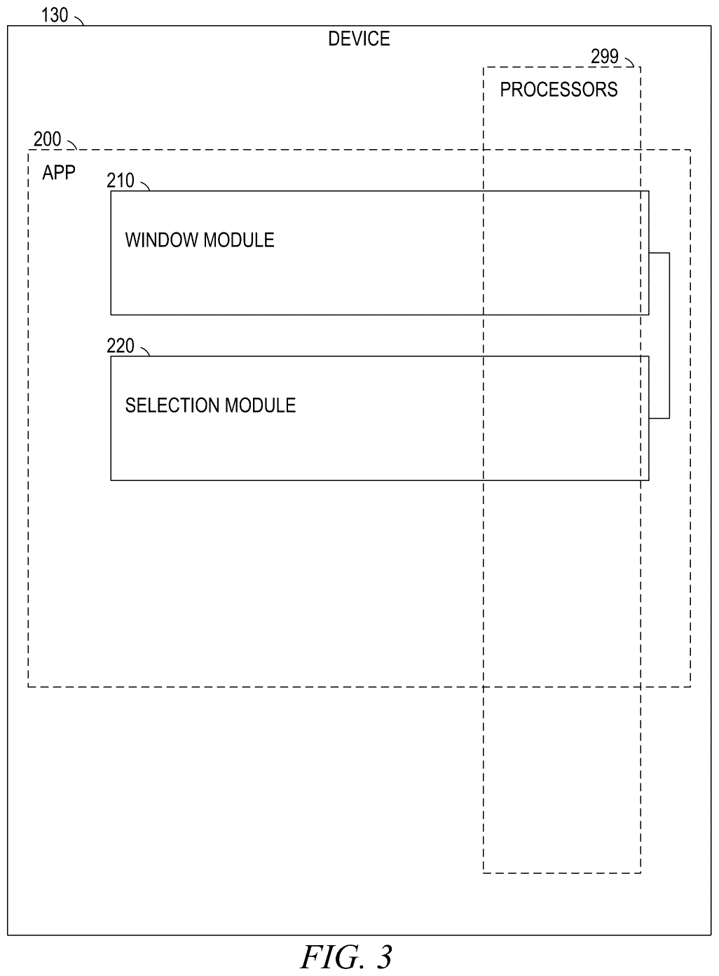

FIG. 3 is a block diagram illustrating components of the device 130, configured for information selection in a table displayed with a generated window, according to some example embodiments. The device 130 is shown as including a window module 210 (e.g., a window generation module or suitable code to generate a window, as described herein) and a selection module 220 (e.g., an information selection module or suitable code to select information), which are configured to communicate with each other (e.g., via a bus, shared memory, or a switch).

As shown in FIG. 3, the window module 210 and the selection module 220 may form all or part of an app 200 (e.g., a mobile app) that is stored (e.g., installed) on the device 130 (e.g., responsive to or otherwise as a result of data being received via the network 190, such as from the database 115 or from the machine 110). Furthermore, one or more processors 299 (e.g., hardware processors, digital processors, or any suitable combination thereof) may be included (e.g., temporarily or permanently) in the app 200, the window module 210, the selection module 220, or any suitable combination thereof.

Any one or more of the components (e.g., modules) described herein may be implemented using hardware alone (e.g., one or more of the processors 299) or a combination of hardware and software. For example, any component described herein may physically include an arrangement of one or more of the processors 299 (e.g., a subset of or among the processors 299) configured to perform the operations described herein for that component. As another example, any component described herein may include software, hardware, or both, that configure an arrangement of one or more of the processors 299 to perform the operations described herein for that component. Accordingly, different components described herein may include and configure different arrangements of the processors 299 at different points in time or a single arrangement of the processors 299 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various example embodiments, components described herein as being implemented within a single system or machine (e.g., a single device) may be distributed across multiple systems or machines (e.g., multiple devices).

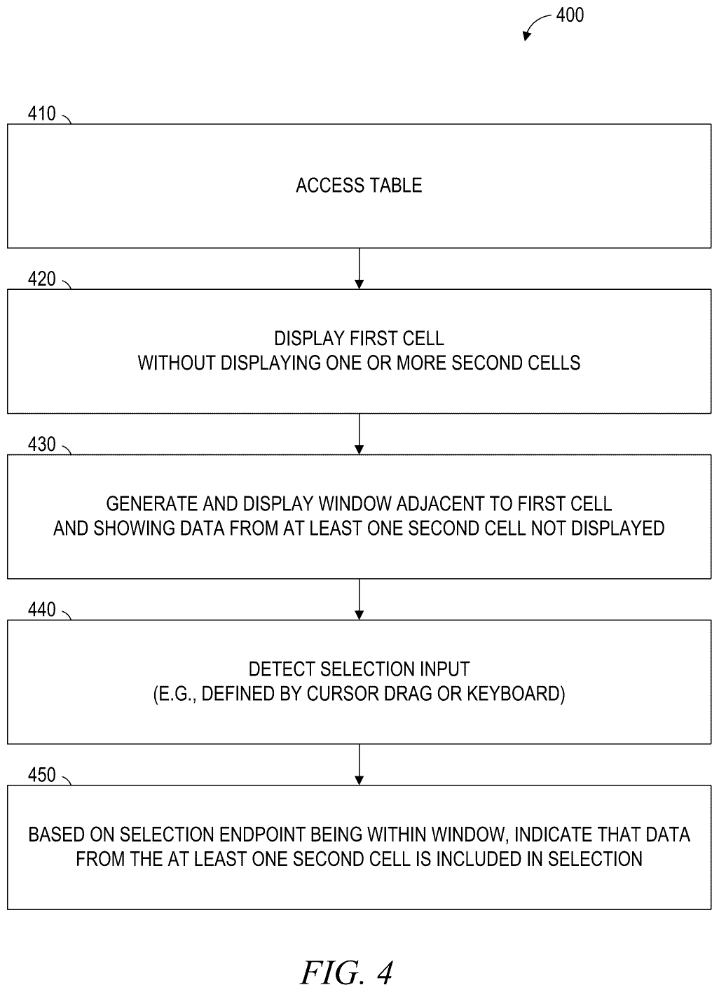

FIGS. 4-6 are flowcharts illustrating operations in performing a method 400 of information selection in a table displayed with a generated window, according to some example embodiments. Operations in the method 400 may be performed by the machine 110, the device 130, or both, using components (e.g., modules) described above with respect to FIGS. 2, 3, or both, using one or more processors (e.g., microprocessors or other hardware processors), or using any suitable combination thereof. As shown in FIG. 4, the method 400 includes operations 410, 420, 430, 440, and 450.

In operation 410, the window module 210 accesses (e.g., from the database 115) a table that includes cells arranged in columns and rows.

In operation 420, the window module 210 displays (e.g., on a display screen) a first cell of the table. The displayed first cell is in a row that includes one or more second cells of the table, where the one or more second cells are in columns that are not being displayed (e.g., in one or more columns that are currently hidden, off-screen, cropped, truncated, or otherwise not visible). For clarity and conciseness, the method 400 is described consistently herein in a context where the one or more second cells are from the same table as the first cell but in one or more columns that are not currently visible. However, the method 400 is also applicable to other contexts in which any type of data source (e.g., a second cell or other repository of data, large or small) with information having a correspondence relationship (e.g., mapping, linking, or other association) with the displayed first cell is not currently visible for one or more alternative reasons (e.g., being in a non-visible row of the same table, in a non-visible entirely different table, in a dismissed pop-up window, or provided by an information service that has no visible user interface, either temporarily or permanently).

In operation 430, the window module 210 generates and displays a window (e.g., a generated window) adjacent to the displayed first cell and showing data from at least one of the one or more second cells that are not being displayed. In some example implementations, the generated window allows for different functionality than the cells of the table. As an example, the user may be able to create, read, update, or delete (CRUD) data in a cell, whereas the data displayed in the generated window may read-only. In other examples, both the cells and the generated window allow CRUD operations on their respective data therein, or the generated window allows CRUD operations while the cells are limited to read-only operation.

In operation 440, the selection module 220 detects (e.g., receives) a selection input (e.g., via an input device, such as a mouse or a keyboard). The detected selection input has a selection endpoint, and the selection input defines a selection of information (e.g., from the information being displayed).

In operation 450, based on the selection endpoint of the selection input being within the window (e.g., the generated window) that is displayed adjacent to the first cell, the selection module 220 indicates (e.g., with a visual indicator, such as with a highlight color) that the data from the at least one of the non-shown (e.g., non-displayed, or otherwise non-visible) one or more second cells and shown in the window (e.g., the generated window displayed adjacent to the first cell) is included in the selection of information defined by the selection input.

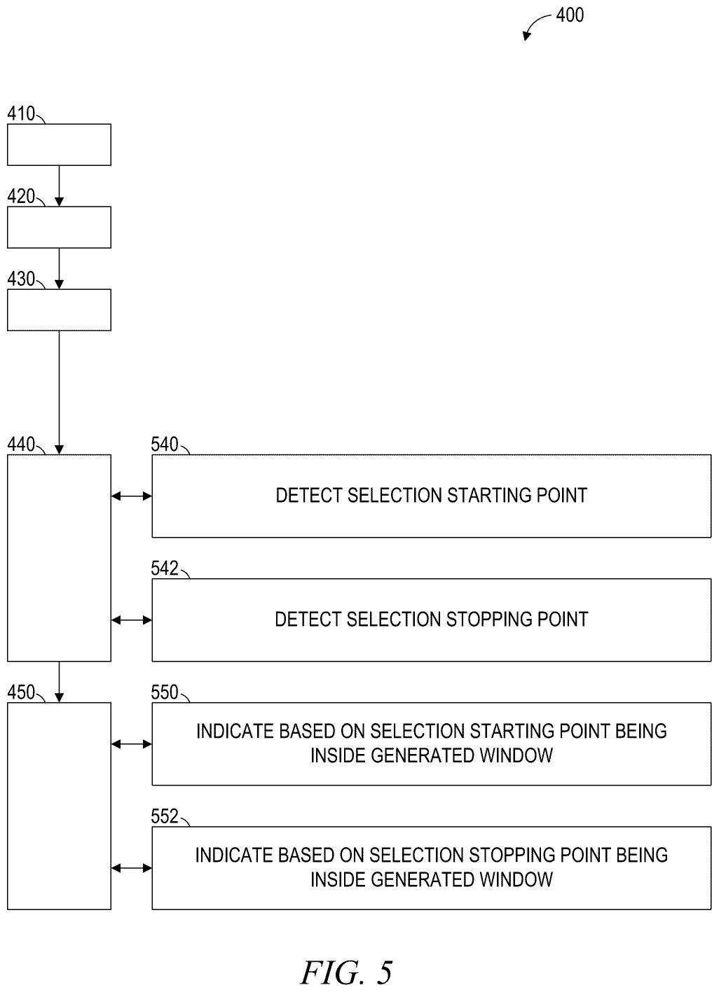

As shown in FIG. 5, in addition to any one or more of the operations previously described, the method 400 may include one or more of operations 540, 542, 550, and 552. One or more of operations 540 and 542 may be performed as part (e.g., a precursor task, a subroutine, or a portion) of operation 440, in which the selection module 220 detects the selection input that has the selection endpoint and that defines the selection of information.

In operation 540, the selection module 220 detects that the selection endpoint of the selection input is a selection starting point (e.g., a beginning, initiation, or other commencement of the selection input, such as a start of a cursor drag).

In operation 542, the selection module 220 detects that the selection endpoint of the selection input is a selection stopping point (e.g., an ending, termination, or other cessation of the selection input, such as a stoppage of a cursor drag).

One or more of operations 550 and 552 may be performed as part (e.g., a precursor task, a subroutine, or a portion) of operation 450, in which the selection module 220 indicates that the data from the at least one of the non-shown one or more second cells and shown in the window (e.g., the generated window displayed adjacent to the first cell) is included in the selection of information defined by the selection input.

In operation 550, the selection module 220 performs the indicating action of operation 450 (e.g., indicating that the data from the at least one of the one or more second cells and shown in the window is included in the selection) based on results of operation 540, namely, based on the selection starting point being within the window (e.g., the generated window) displayed adjacent to the first cell. For example, the selection module 220 may execute two actions: first, selecting the data from the at least one of the non-shown one or more second cells for inclusion in the upcoming selection of information, based on the selection starting point being within the window; and second, indicating (e.g., with a highlight color on a display) that the selected data is indeed selected, which may also be based on the selection starting point being within the window.

In operation 552, the selection module 220 performs the indicating action of operation 450 (e.g., indicating that the data from the at least one of the one or more second cells and shown in the window is included in the selection) based on results of operation 542, namely, based on the selection stopping point being within the window (e.g., the generated window) displayed adjacent to the first cell. For example, the selection module 220 may execute two actions: first, selecting the data from the at least one of the non-shown one or more second cells for inclusion in the upcoming selection of information, based on the selection stopping point being within the window; and second, indicating (e.g., with a highlight color on a display) that the selected data is indeed selected, which may also be based on the selection stopping point being within the window.

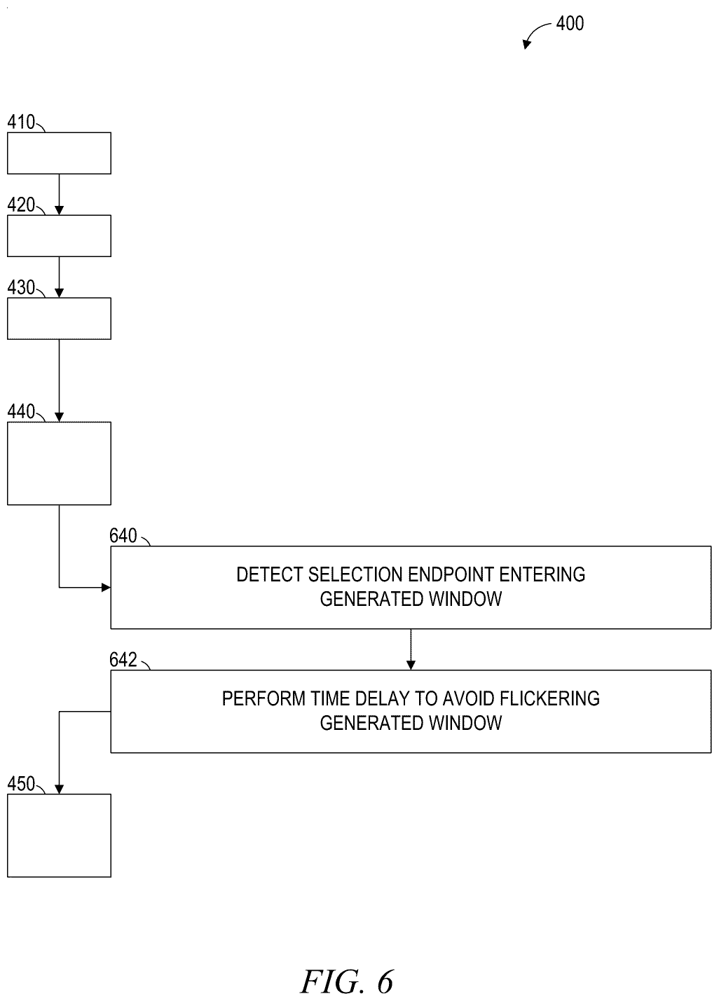

As shown in FIG. 6, in addition to any one or more of the operations previously described, the method 400 may include one or more of operations 640 and 642.

In operation 640, the selection module 220 detects that the selection endpoint of the selection input entered the window (e.g., the generated window) displayed adjacent to the first cell.

In operation 642, the selection module 220 performs a time delay (e.g., a predetermined time delay) after the selection endpoint entered the window and before the upcoming performance of operation 450 (e.g., selecting the data from the at least one of the one or more second cells and shown in the window, and indicating that this selected data is included in the selection of information). That is, the time delay may be performed between completion of operation 640 and initiation of operation 450. This may have the beneficial effect of reducing or eliminating flickering effects in displaying the window (e.g., the generated window) displayed adjacent to the first cell.

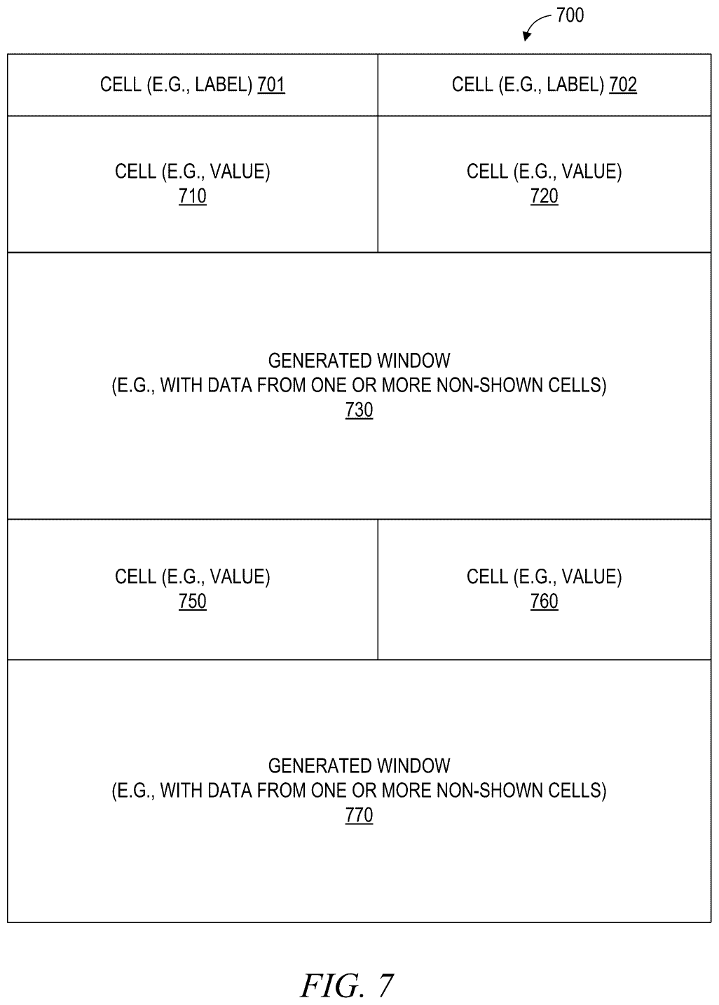

FIG. 7 is a user-interface diagram illustrating a user interface 700 displaying some cells (e.g., cells 701, 702, 710, 720, 750, and 760) of a table and displaying some generated windows (e.g., generated windows 730 and 770), each generated window showing data from one or more non-shown cells of the table, according to some example embodiments.

In the example embodiments shown in FIG. 7, cells 701 and 702 are in different columns but in the same row, which may have one or more additional cells in further columns that are not shown in the user interface 700. Similarly, cells 710 and 720 are in different columns but in the same row, which may have one or more additional cells in further columns not shown in the user interface 700. Likewise, cells 750 and 760 are in different columns but in the same row, which may have one or more additional cells in further columns not shown in the user interface 700.

Cell 701 may contain a label (e.g., “Product”) for its column, and that label may apply to the values of cells 710 and 750 in different rows but in the same column as cell 701; that is, the values of cells 710 and 750 may quantify or otherwise correspond to the label (e.g., column label) in cell 701 (e.g., while excluding that label from being explicitly shown in those cells 710 and 750). Similarly, cell 702 may contain a label (e.g., “Price”) for its column, and that label may apply to the values of cells 720 and 760 in different rows but in the same column as cell 702; that is, the values of cells 720 and 760 may quantify or otherwise correspond to the label (e.g., column label) in cell 702 (e.g., while excluding that label from being explicitly shown in those cells 720 and 760).

In situations where there are one or more additional columns not shown in the user interface (e.g., due to truncation from zooming in), the window module 210 may generate and display the generated window 730 within the user interface 700, where the generated window 730 may show data (e.g., one or more values, with or without corresponding column labels) from one or more of the additional cells that are in the same row as cells 710 and 720 but are not displayed in the user interface 700 (e.g., one or more cells that would be displayed to the left of cell 710, one or more cells that would be displayed to the right of cell 720, or a combination of both). Similarly, the window module 210 may generate and display the generated window 770 within the user interface 700, where the generated window 770 may show data (e.g., one or more values, with or without corresponding column labels) from one or more of the additional cells that are in the same row as cells 750 and 760 but are not displayed in the user interface 700 (e.g., one or more cells that would be displayed to the left of cell 750, one or more cells that would be displayed to the right of cell 760, or a combination of both).

While the user interface 700 may visually display generated windows (e.g., generated windows 730 and 770) in a manner similar to (e.g., identical to) actual cells (e.g., cells 710, 720, 750, and 760), any generated windows are not the same as cells, but rather display data from one or more non-displayed cells in proximity (e.g., adjacent) to actual displayed cells from the same row. In some example implementations, the generated windows 730 and 770 each occupy a row-like region of visual space within the user interface 700 but are not themselves rows of the table. Instead, each generated window may be displaying data from one or more columns not presently visible in the user interface 700. As an example, for generated window 730, the data presented therein may come from one or more cells in columns to the left of cell 710 or to the right of cell 720 and in the same row as cells 710 and 720. In this way, non-visible data in off-screen columns can be shown by displaying the generated window 730 in a visual row-like region that is adjacent to the row containing cells 710 and 720. In other example implementations, the orientation of FIG. 7 is rotated 90 degrees such that data presented in the generated windows 730 and 770 are displayed in a visual column-like region and display data from presently non-visible rows associated with presently visible rows.

Selection of information may begin within a cell (e.g., a first cell, such as cell 710) or within a generated window (e.g., generated window 730). For example, selection of information may be initiated (e.g., independently of any current cursor focus within the user interface 700) by a mouse input (e.g., a click), a keyboard input (e.g., a SPACE), or a hybrid input (e.g., a CTRL+click) that designates a displayed cell (e.g., a first cell, such as cell 710) or by dragging a cursor (e.g., a mouse cursor) from one displayed cell (e.g., a first cell, such as cell 710) to another location in the user interface 700. Using mouse input, the cursor may be dragged to another displayed cell (e.g., cell 720) or to a generated window (e.g., generated window 730), thus resulting in creation and visual indication of a selection block (e.g., a selected group of cells). Using keyboard input, the selection block may be extended by using arrow keys (e.g., SHIFT+ARROW UP, SHIFT+ARROW DOWN, SHIFT+ARROW RIGHT, or SHIFT+ARROW LEFT).

In general, a selection input may start anywhere in the user interface 700, and the selection input may stop anywhere else in the user interface 700. Accordingly, the selection input generally may encompass one or more cells, one or more generated windows, or any combination thereof. If a selection input starts within a generated window (e.g., generated window 730), stops within a generated window (e.g., generated window 770), or both, then data from all generated windows encompassed by the selection input are included in the selection of information, and the user interface 700 is updated by the selection module 220 to visually indicate such (e.g., by visually highlighting those generated windows in the same manner as for cells that also included in the same selection of information).

In some example embodiments, if a selection input starts within a generated window (e.g., generated window 730), the only cells that can then be added for inclusion in the selection input are those displayed cells that are in the same row as the one or more non-displayed cells whose data (e.g., values) are shown in the generated window. Accordingly, a selection input that starts in one generated window (e.g., generated window 730) and stops in a different generated window (e.g., generated window 770) will select the data from those one or more second cells associated with those generated windows (e.g., as well as any intervening generated windows encompassed by the selection input), but may exclude the data displayed in associated visible cells (e.g., cells 710, 720, 750, and 760). A selection input that starts in a generated window (e.g., generated window 730) and stops in a cell (e.g., cell 720) in the same row as one or more cells whose data is shown in the generated window will select the data shown in that generated window and the data shown in that cell (e.g., as well as any intervening cells from that same row). Similarly, a selection input that starts in a cell (e.g., cell 710) and stops in generated window (e.g., generated window 730) whose data comes from one or more non-shown cells in the same row as the cell will select the data shown in that cell and the data shown in that generated window (e.g., as well as any intervening cells from that same row).

In certain example embodiments, to avoid introducing flickering effects in the user interface 700, a time delay (e.g., with a predetermined duration) is added between a first time when the selection input enters a cell or a generated window and a second time when the selection module 220 updates the user interface 700 to visually indicate the current selection of information. For example, the selection module 220 may perform such a time delay between the selection endpoint of the selection input entering a generated window (e.g., generated window 730) and the performance of operation 450 in the method 400.

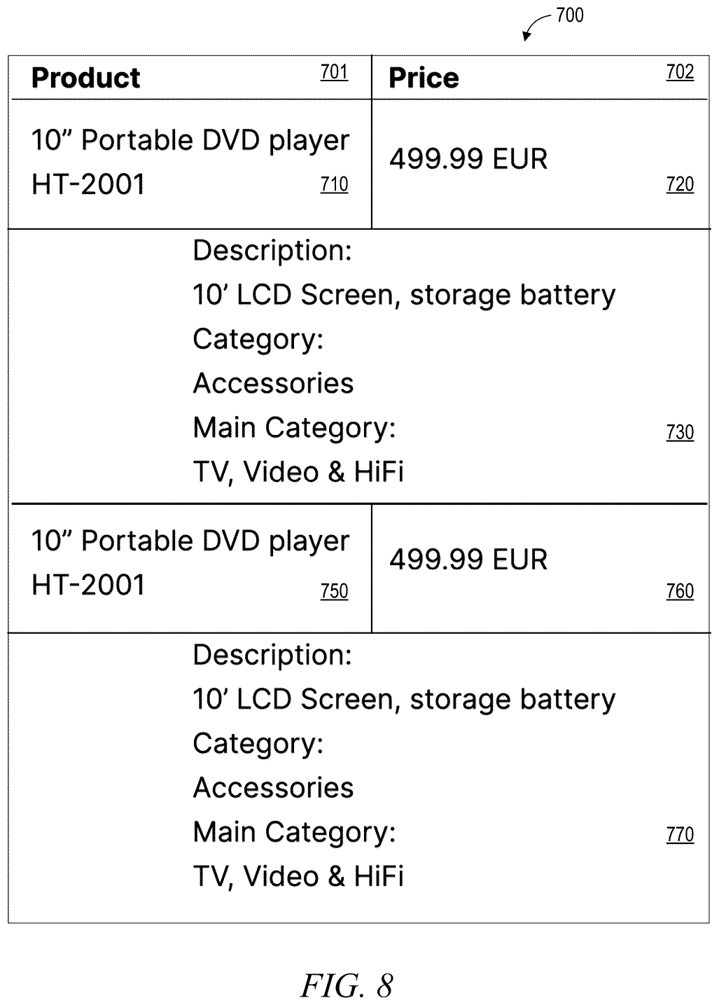

FIGS. 8-11 are user-interface screenshots illustrating sequential phases in selection of information across rows of a table by using a cursor drag input (e.g., dragging a mouse pointer) that moves from left to right, according to some example embodiments. The user interface 700 may be displayed (e.g., by the machine 110, the device 130, or both) with sequential visual appearances that correspond to such sequential phases.

In FIG. 8, the user interface 700 is in an initial state with an initial appearance, without any information selected. It should be noted that while some of the example information displayed in the various cells and generated windows is identical, this is not a requirement to implement this invention. Other electronic devices, such as flat screen televisions, could be included in the associated data table, but the display might not be large enough, and thus the associated data may be in non-visible cells and non-visible windows in rows above or below the rows of cells and generated windows displayed in FIGS. 8-33. It should also be noted that while the example information shown in FIGS. 8-33 is identical, distinguishing data may also exist, but is accounted for in one or more non-visible columns. As an example, a warehouse location could be an additional, non-visible column to the data displayed in FIGS. 8-33 and thus offer distinguishing data associated with the data that is displayed.

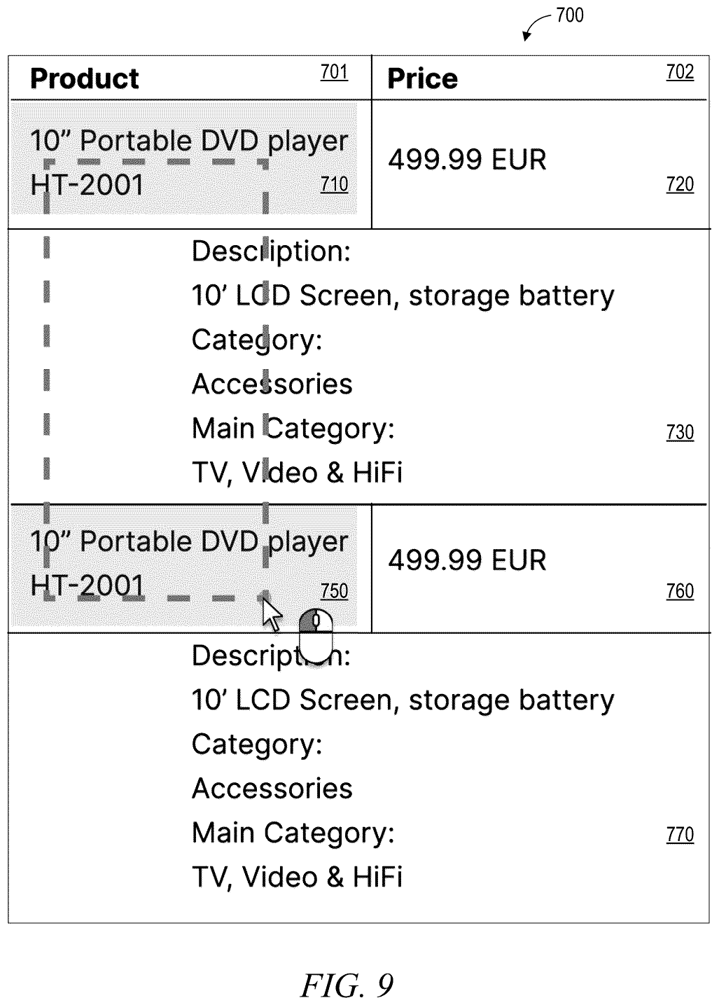

In FIG. 9, a cursor drag input is indicated by a dark blue dashed rectangle. As indicated, the cursor drag input began in one cell (e.g., cell 710) in one row and was dragged downward and rightward to another cell (e.g., cell 750) in another row. The cursor drag input was generated by a left click on a mouse, as indicated by a red highlight on a mouse icon. The user interface 700 uses light blue highlights to indicate that the two cells (e.g., cells 710 and 750) are selected (e.g., included in the selection of information). Since the cursor drag input did not start or stop in a generated window, no generated window is selected.

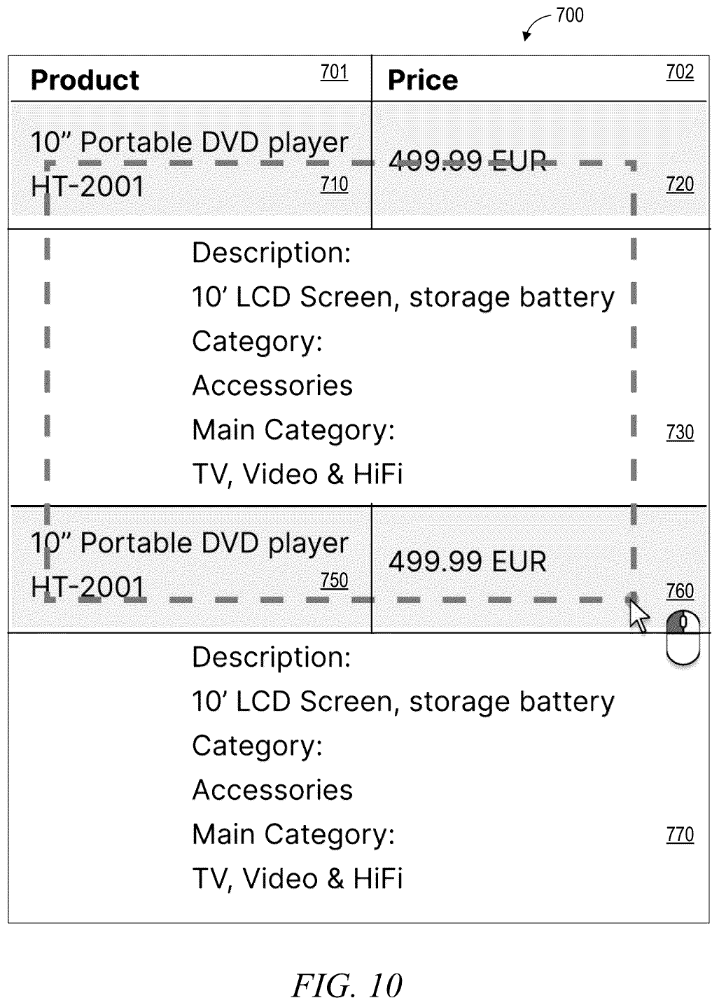

In FIG. 10, the cursor drag input has extended rightward and continues to be indicated by the dark blue dashed rectangle. As indicated, the cursor drag input has extended rightward to a further cell (e.g., cell 760). The cursor drag input was generated by a left click on a mouse, as indicated by a red highlight on a mouse icon. The user interface 700 uses light blue highlights to indicate that four cells (e.g., cells 710, 720, 750, and 760) are selected (e.g., included in the selection of information). Since the cursor drag input did not start or stop in a generated window, no generated window is selected.

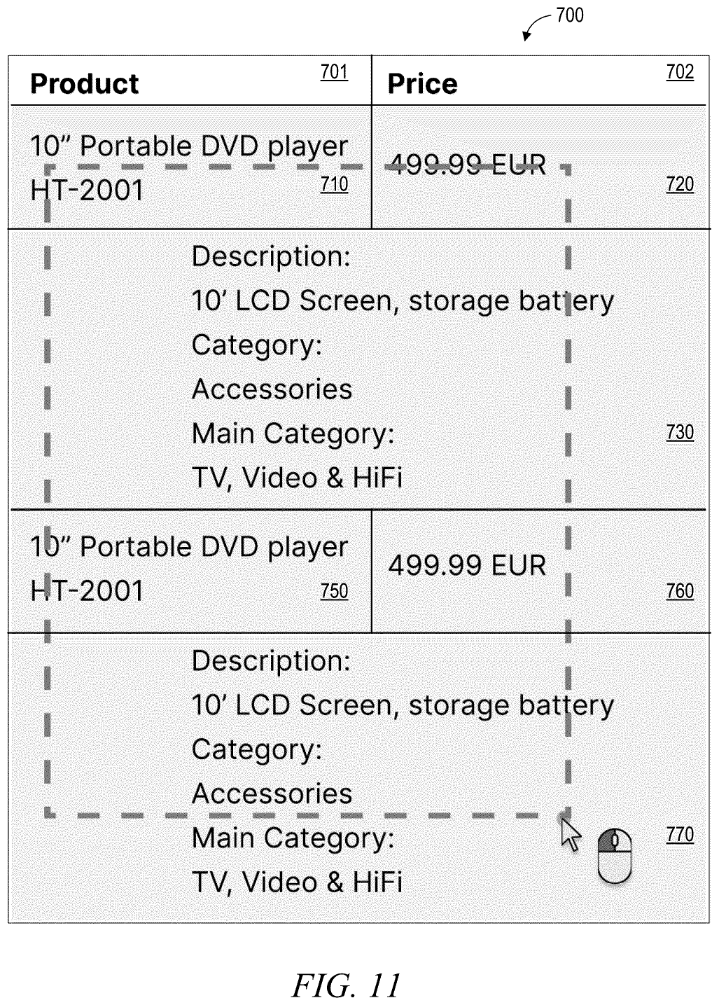

In FIG. 11, the cursor drag input has extended downward and continues to be indicated by the dark blue dashed rectangle. As indicated, the cursor drag input has extended downward to a generated window (e.g., generated window 770). The cursor drag input was generated by a left click on a mouse, as indicated by a red highlight on a mouse icon. The user interface 700 uses light blue highlights to indicate that four cells (e.g., cells 710, 720, 750, and 760) and two generated windows (e.g., generated windows 730 and 770) are selected (e.g., included in the selection of information). Since the cursor drag input stopped in a generated window, all generated windows whose data comes from non-shown cells in the same rows as selected cells are now selected.

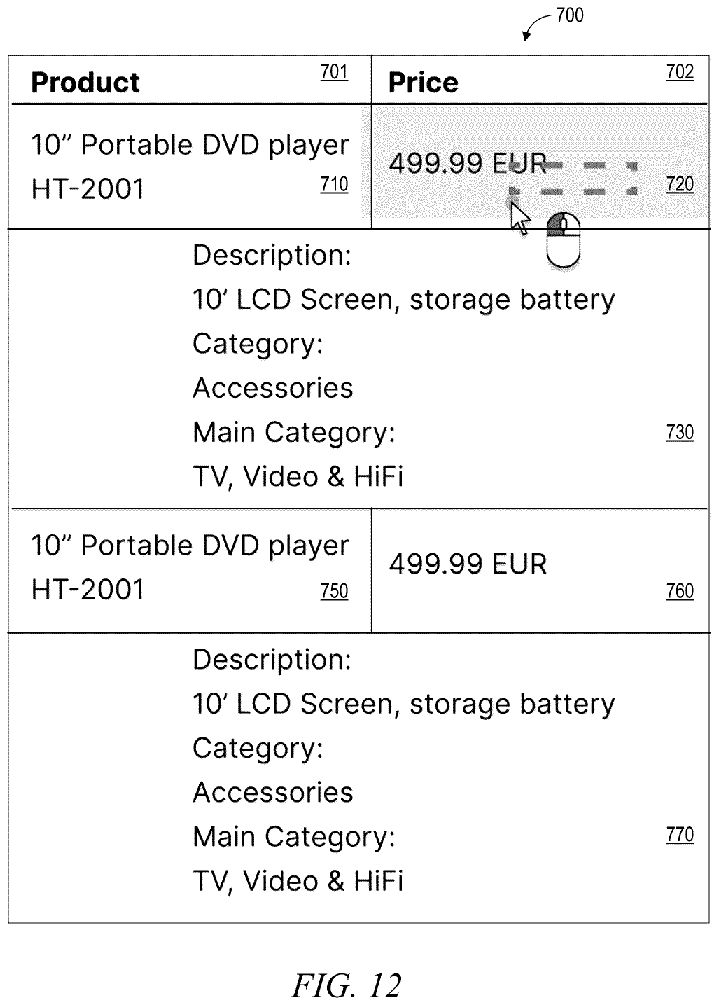

FIGS. 12-16 are user-interface screenshots illustrating sequential phases in selection of information across rows of a table by using a cursor drag input that moves from right to left, according to some example embodiments. The user interface 700 may be displayed (e.g., by the machine 110, the device 130, or both) with sequential visual appearances that correspond to such sequential phases.

In FIG. 12, a cursor drag input is indicated by a dark blue dashed rectangle. As indicated, the cursor drag input began in one cell (e.g., cell 720) and was dragged downward and leftward while remaining inside that same cell. The cursor drag input was generated by a left click on a mouse, as indicated by a red highlight on a mouse icon. The user interface 700 uses a light blue highlight to indicate that the one cell (e.g., cell 720) is selected (e.g., included in the selection of information). Since the cursor drag input did not start or stop in a generated window, no generated window is selected.

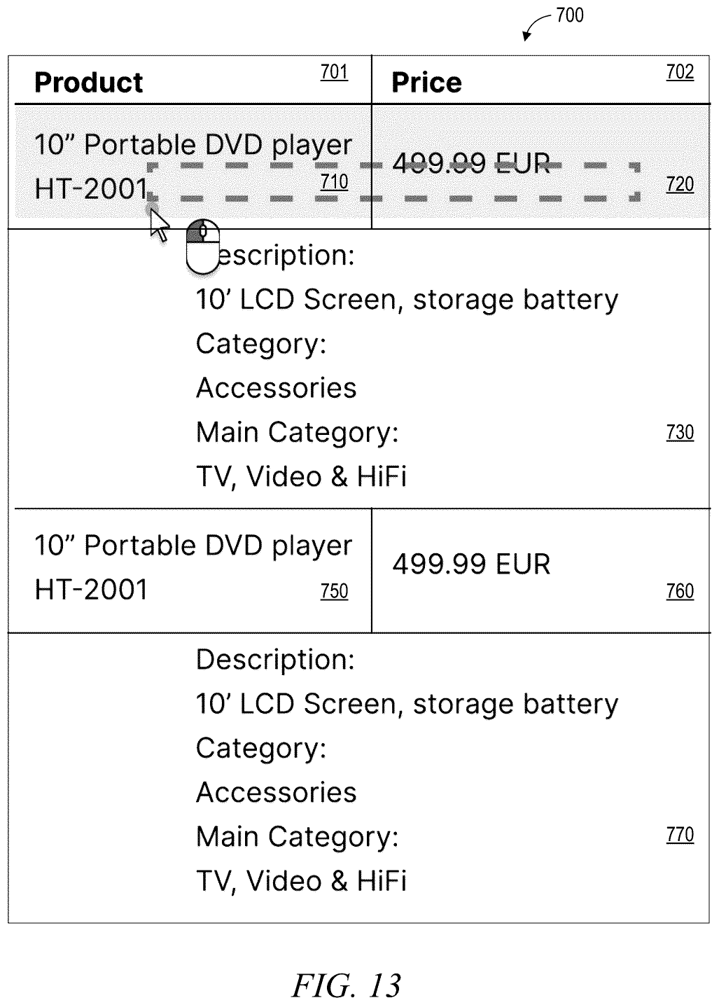

In FIG. 13, the cursor drag input has extended leftward and continues to be indicated by the dark blue dashed rectangle. As indicated, the cursor drag input has extended leftward to a further cell (e.g., cell 710). The cursor drag input was generated by a left click on a mouse, as indicated by a red highlight on a mouse icon. The user interface 700 uses light blue highlights to indicate that the two cells (e.g., cells 710 and 720) are selected (e.g., included in the selection of information). Since the cursor drag input did not start or stop in a generated window, no generated window is selected.

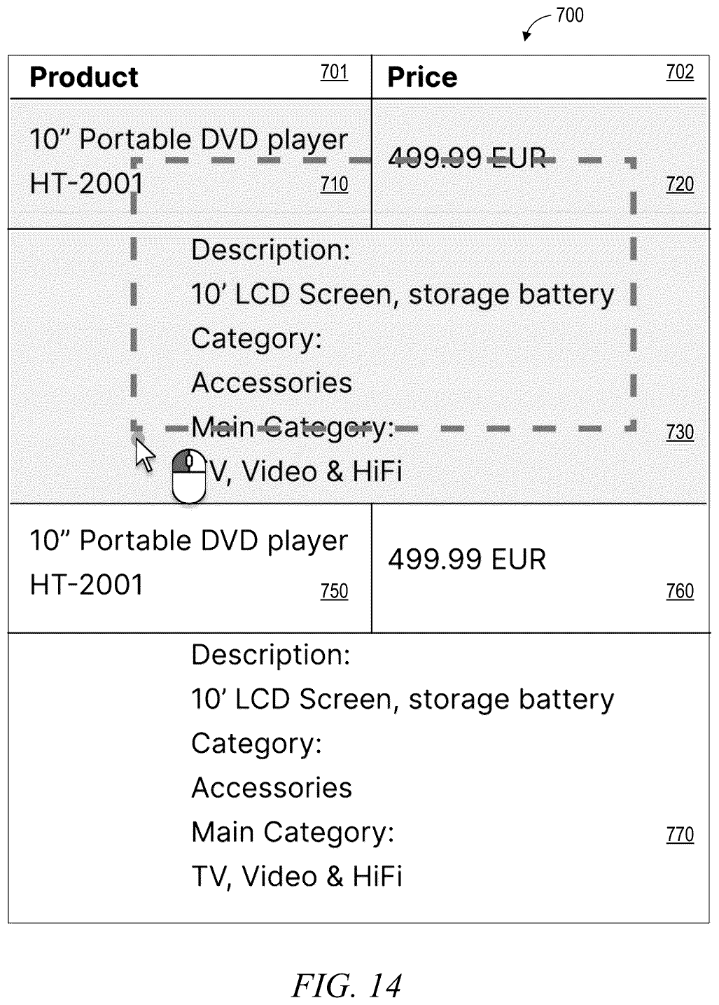

In FIG. 14, the cursor drag input has extended downward and continues to be indicated by the dark blue dashed rectangle. As indicated, the cursor drag input has extended downward to a generated window (e.g., generated window 730). The cursor drag input was generated by a left click on a mouse, as indicated by a red highlight on a mouse icon. The user interface 700 uses light blue highlights to indicate that two cells (e.g., cells 710 and 720) and one generated window (e.g., generated window 730) are selected (e.g., included in the selection of information). Since the cursor drag input stopped in a generated window, the generated window is now selected. That is, according to some example embodiments, not only is the data in cells 710 and 720 selected, but so is the data in the cells in one or more non-visible columns (e.g., off-screen to the left of cell 710, off-screen to the right of cell 720, or both) and in the same row as cells 710 and 720.

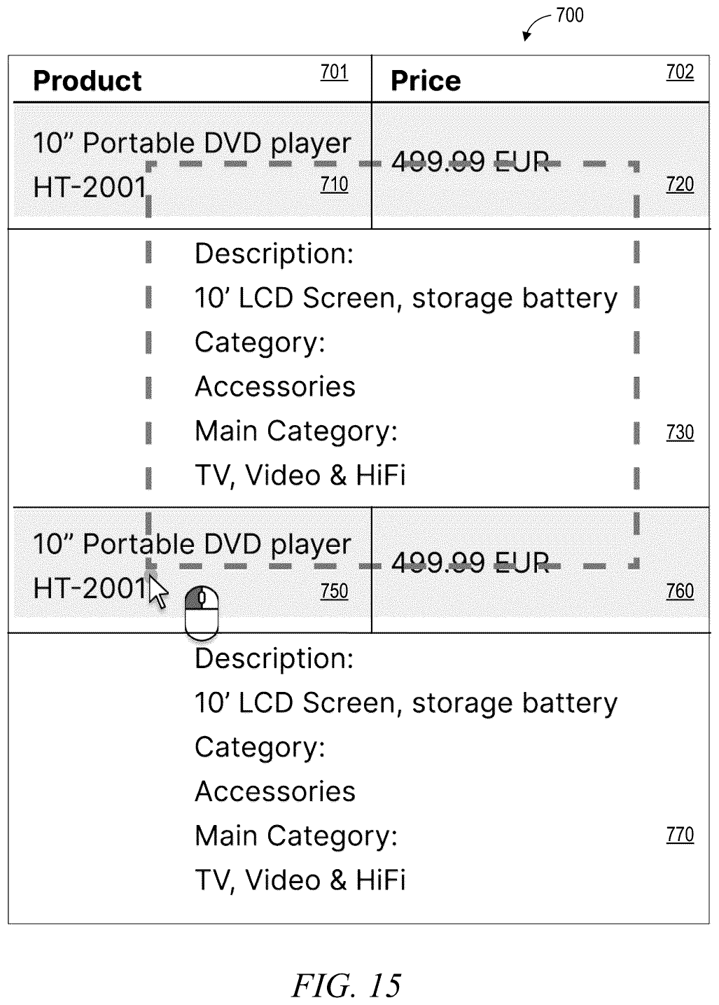

In FIG. 15, the cursor drag input has extended further downward and continues to be indicated by the dark blue dashed rectangle. As indicated, the cursor drag input has extended further downward to another cell (e.g., cell 750). The cursor drag input was generated by a left click on a mouse, as indicated by a red highlight on a mouse icon. The user interface 700 uses light blue highlights to indicate that four cells (e.g., cells 710, 720, 750, and 760) and no generated windows are selected (e.g., included in the selection of information). Since the cursor drag input did not start or stop in a generated window, no generated window is selected. Thus, the data selected is limited to the data of cells 710, 720, 750, and 760.

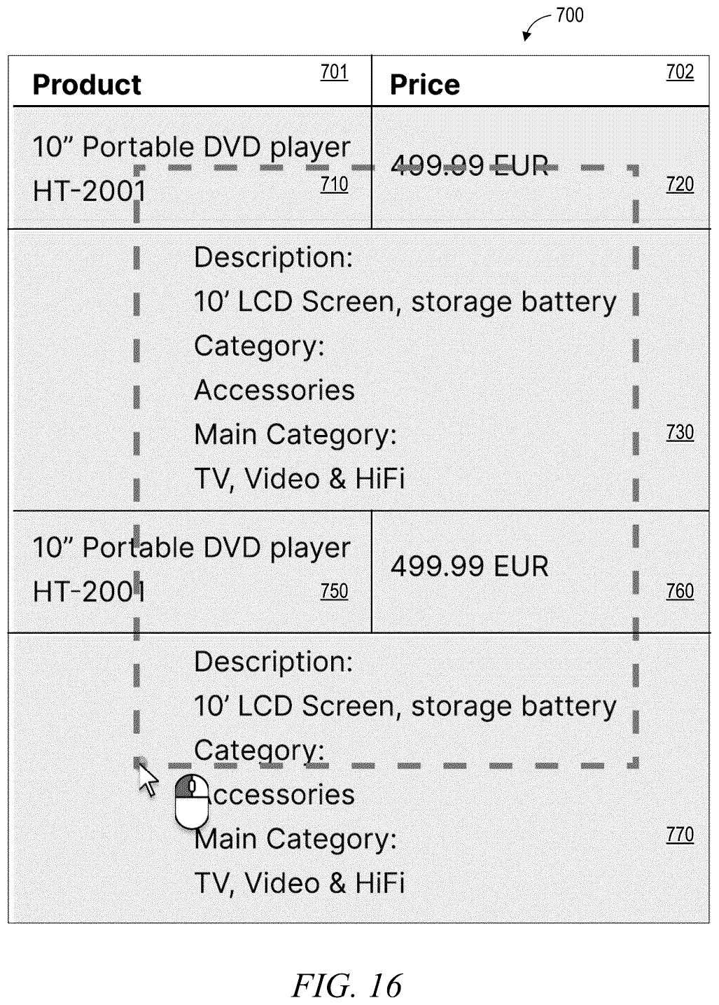

In FIG. 16, the cursor drag input has extended still further downward and continues to be indicated by the dark blue dashed rectangle. As indicated, the cursor drag input has extended still further downward to a generated window (e.g., generated window 770). The cursor drag input was generated by a left click on a mouse, as indicated by a red highlight on a mouse icon. The user interface 700 uses light blue highlights to indicate that four cells (e.g., cells 710, 720, 750, and 760) and two generated windows (e.g., generated windows 730 and 770) are selected (e.g., included in the selection of information). Since the cursor drag input stopped in a generated window, all generated windows whose data comes from non-shown cells in the same rows as selected cells are now selected.

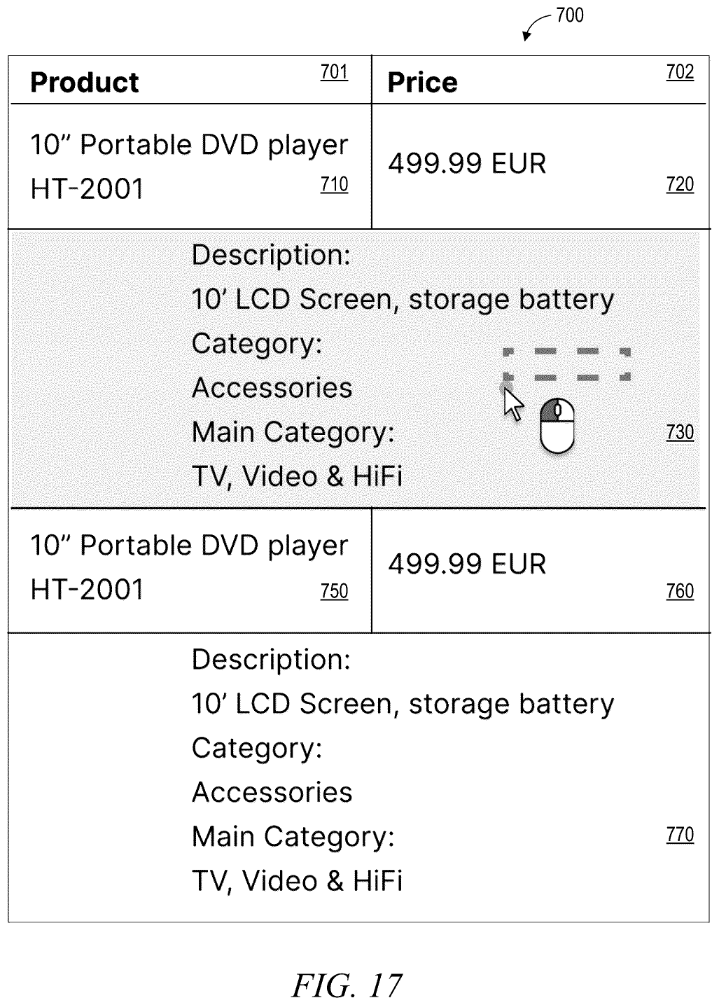

FIGS. 17-19 are user-interface screenshots illustrating sequential phases in selection of information by using a cursor drag input that starts (e.g., initiates) inside a generated window (e.g., generated window 730), according to some example embodiments. The user interface 700 may be displayed (e.g., by the machine 110, the device 130, or both) with sequential visual appearances that correspond to such sequential phases.

In FIG. 17, a cursor drag input is indicated by a dark blue dashed rectangle. As indicated, the cursor drag input began in a generated window (e.g., generated window 730) and was dragged downward and leftward while remaining inside that same generated window. The cursor drag input was generated by a left click on a mouse, as indicated by a red highlight on a mouse icon. The user interface 700 uses a light blue highlight to indicate that the generated window (e.g., generated window 730) is selected (e.g., included in the selection of information). Since the cursor drag input started and stopped in a generated window, the generated window is now selected.

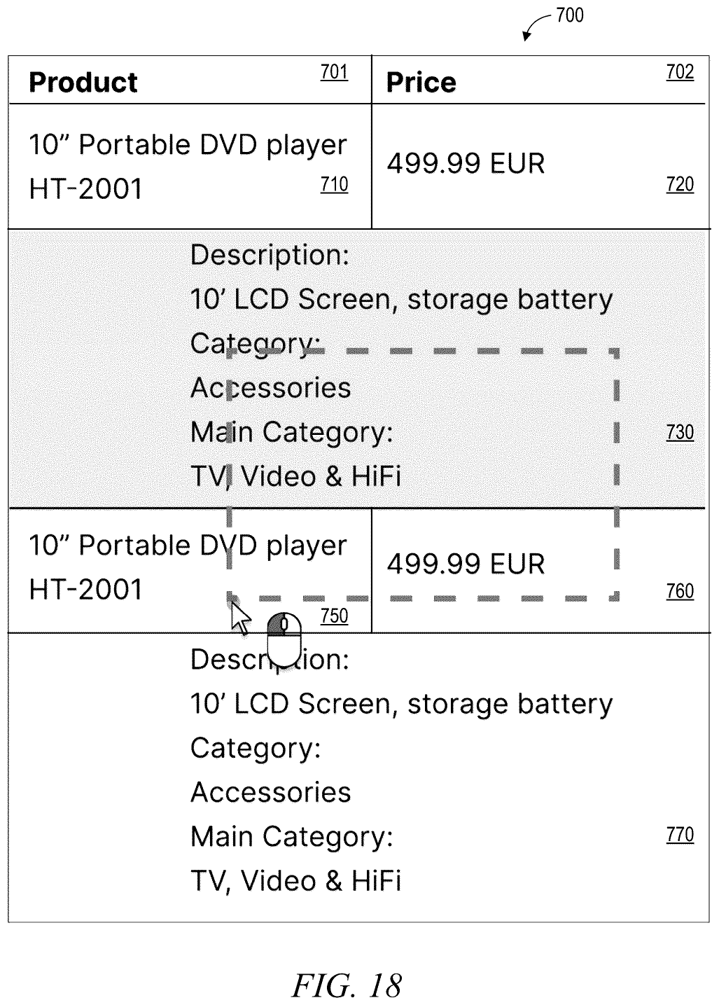

In FIG. 18, the cursor drag input has extended leftward and downward from its state in FIG. 17 and continues to be indicated by the dark blue dashed rectangle. As indicated, the cursor drag input has extended leftward and downward to a cell (e.g., cell 750) in a different row than the non-shown cells whose data appears in the generated window (e.g., generated window 730). The cursor drag input was generated by a left click on a mouse, as indicated by a red highlight on a mouse icon. The user interface 700 uses light blue highlights to indicate that the generated window (e.g., generated window 730) is selected (e.g., included in the selection of information) without including any cells (e.g., cell 750, cell 760, or both). Since the cursor drag input started in a generated window, the generated window is selected.

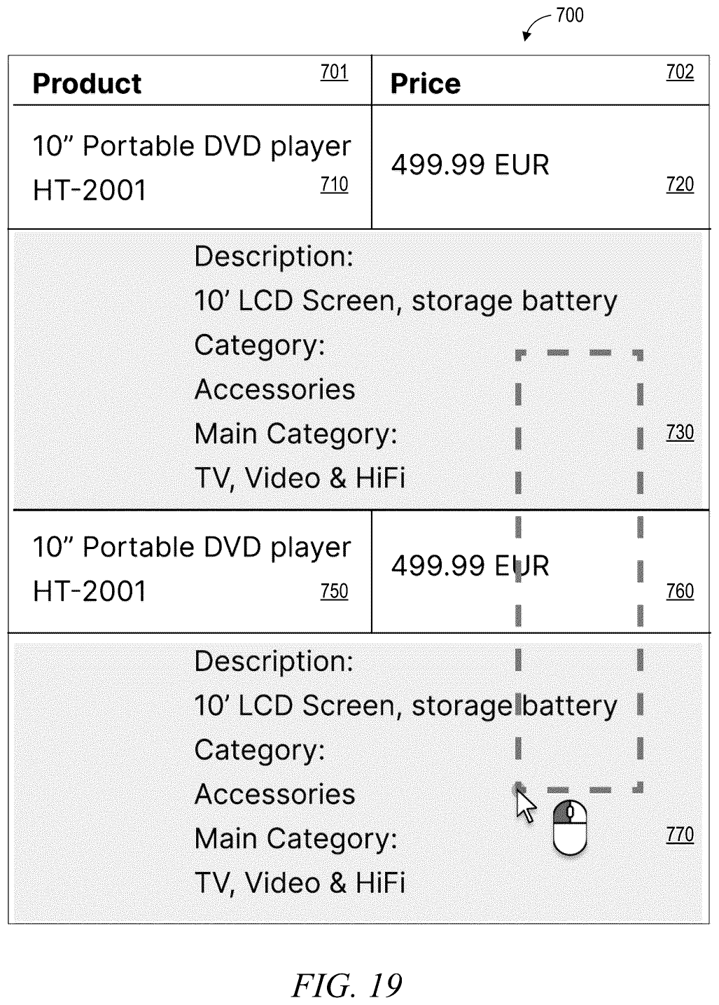

In FIG. 19, the cursor drag input has extended straight downward from its state in FIG. 17 and continues to be indicated by the dark blue dashed rectangle. As indicated, the cursor drag input has extended straight downward to another generated window (e.g., generated window 770). The cursor drag input was generated by a left click on a mouse, as indicated by a red highlight on a mouse icon. The user interface 700 uses light blue highlights to indicate that the two generated windows (e.g., generated windows 730 and 770) are selected (e.g., included in the selection of information) without including any cells (e.g., cell 750, cell 760, or both). Since the cursor drag input started in one generated window and stopped in another generated window, the two generated windows and all generated windows between the two generated windows (e.g., none, in this case) are now selected.

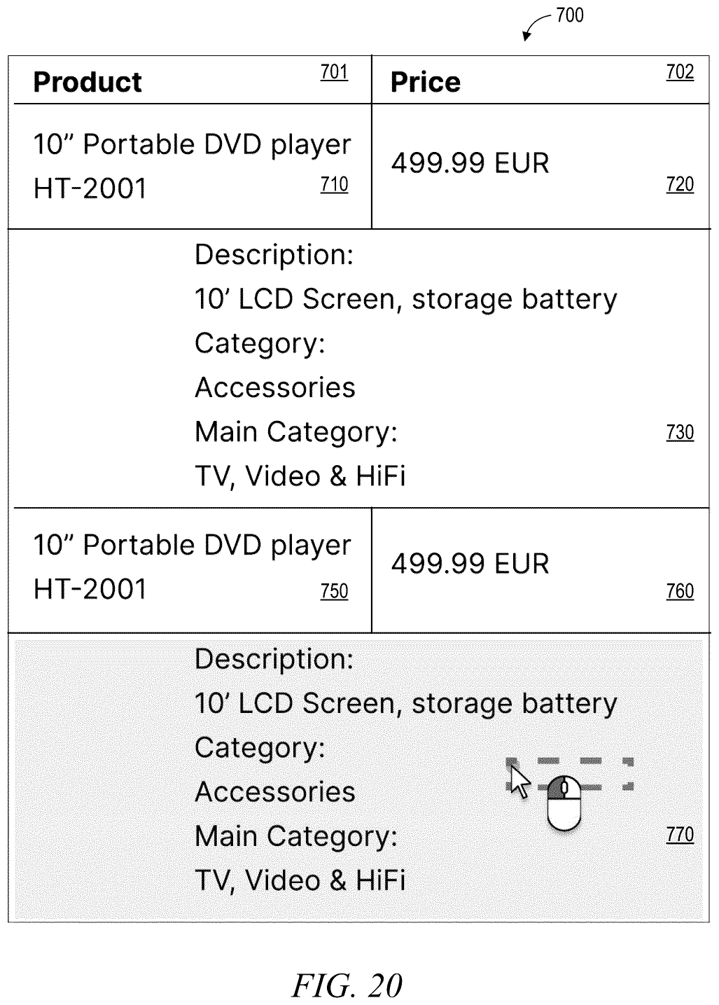

FIGS. 20-24 are user-interface screenshots illustrating sequential phases in selection of information by using a cursor drag input that stops (e.g., terminates) inside a generated window, according to some example embodiments. The user interface 700 may be displayed (e.g., by the machine 110, the device 130, or both) with sequential visual appearances that correspond to such sequential phases.

In FIG. 20, a cursor drag input is indicated by a dark blue dashed rectangle. As indicated, the cursor drag input began in a generated window (e.g., generated window 770) and was dragged upward and leftward while remaining inside that same generated window. The cursor drag input was generated by a left click on a mouse, as indicated by a red highlight on a mouse icon. The user interface 700 uses a light blue highlight to indicate that the generated window (e.g., generated window 770) is selected (e.g., included in the selection of information). Since the cursor drag input started and stopped in a generated window, the generated window is now selected.

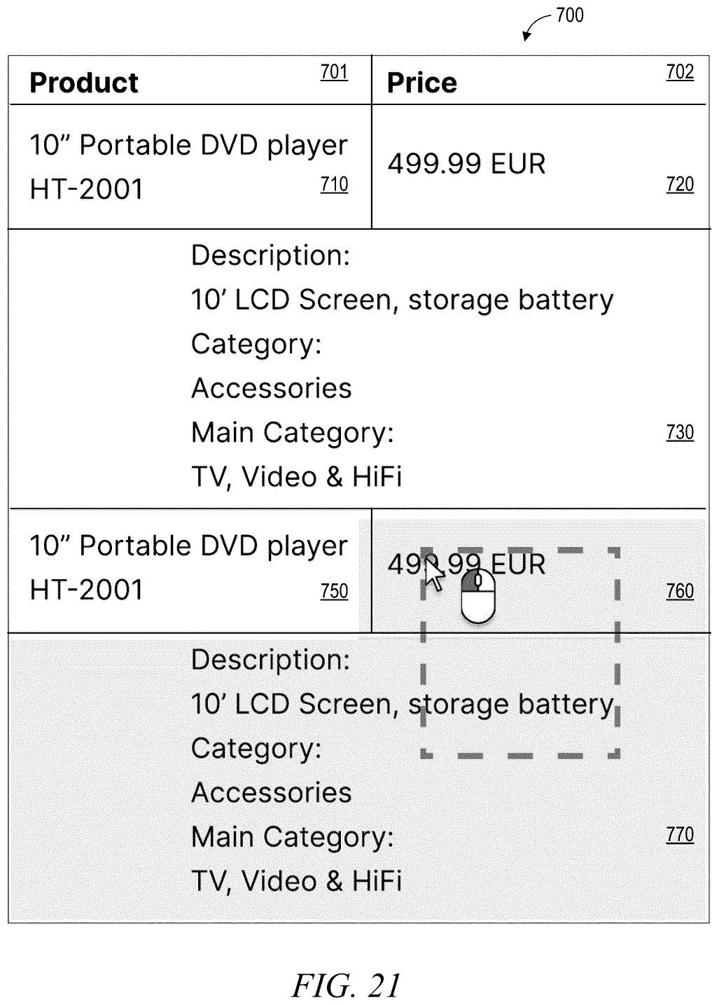

In FIG. 21, the cursor drag input has extended upward and continues to be indicated by the dark blue dashed rectangle. As indicated, the cursor drag input has extended upward to a cell (e.g., cell 760) in the same row as the non-shown cells whose data appears in the generated window (e.g., generated window 770). The cursor drag input was generated by a left click on a mouse, as indicated by a red highlight on a mouse icon. The user interface 700 uses light blue highlights to indicate that the cell (e.g., cell 760) and the generated window (e.g., generated window 770) are selected (e.g., included in the selection of information). Since the cursor drag input started in a generated window, all generated windows whose data comes from non-shown cells in the same rows as selected cells, in this case only that same generated window, are now selected.

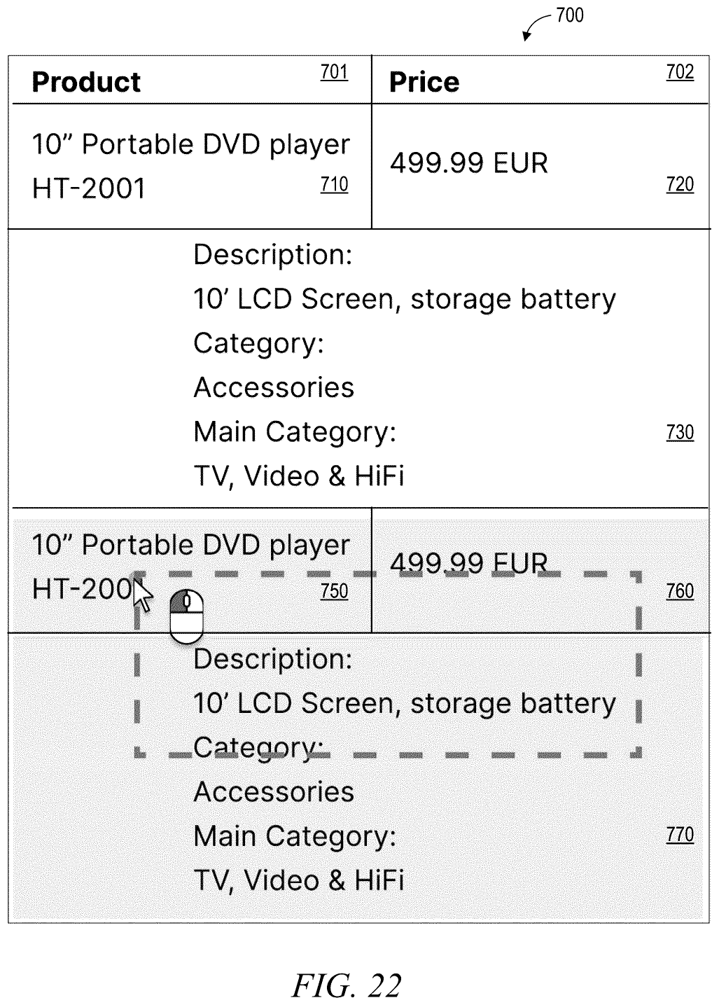

In FIG. 22, the cursor drag input has extended leftward and continues to be indicated by the dark blue dashed rectangle. As indicated, the cursor drag input has extended leftward to a further cell (e.g., cell 750). The cursor drag input was generated by a left click on a mouse, as indicated by a red highlight on a mouse icon. The user interface 700 uses light blue highlights to indicate that two cells (e.g., cells 750 and 760) and the generated window (e.g., generated window 730) are selected (e.g., included in the selection of information). Since the cursor drag input started in a generated window, all generated windows whose data comes from non-shown cells in the same rows as selected cells, in this case only that same generated window, are now selected (e.g., in addition to the cells 750 and 760, as noted above).

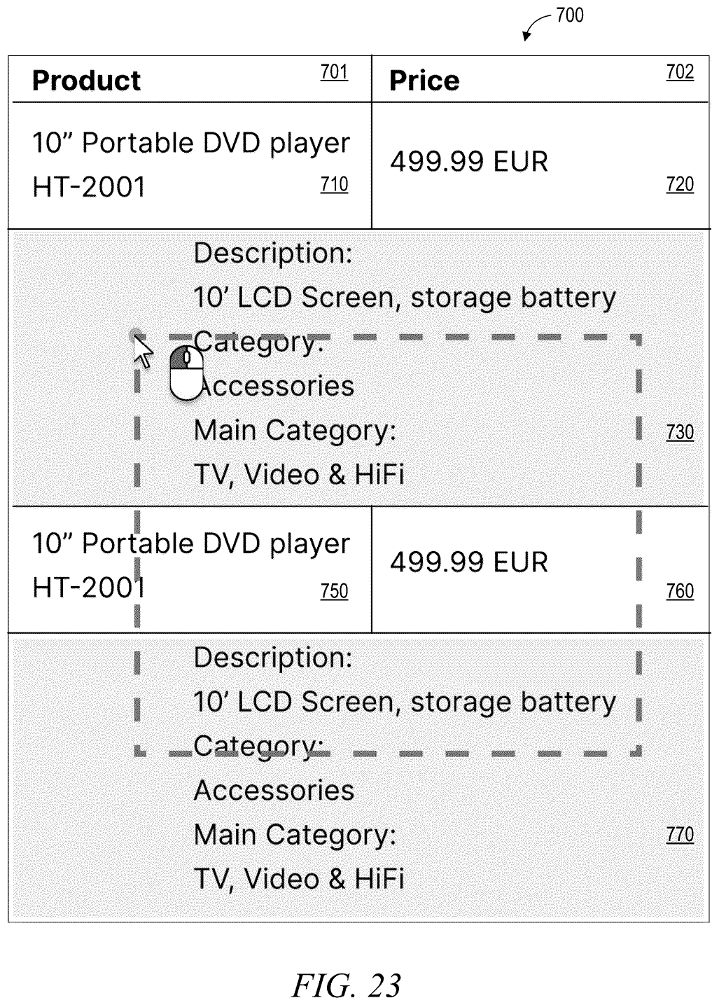

In FIG. 23, the cursor drag input has extended upward and continues to be indicated by the dark blue dashed rectangle. As indicated, the cursor drag input has extended upward to another generated window (e.g., generated window 730). The cursor drag input was generated by a left click on a mouse, as indicated by a red highlight on a mouse icon. The user interface 700 uses light blue highlights to indicate that the two generated windows (e.g., generated windows 730 and 770) are selected (e.g., included in the selection of information) without including any cells (e.g., cell 750, cell 760, or both). Since the cursor drag input started in one generated window and stopped in another generated window, the two generated windows and all generated windows between the two generated windows (e.g., none, in this case) are now selected. Because the selection input started in a generated window (e.g., generated window 770), the only cells that can then be added for inclusion in the selection input are those displayed cells that are in the same row as the one or more non-displayed cells whose data (e.g., values) are shown in that same generated window (e.g., generated window 770). However, there are no such cells in this situation, and accordingly no cells (e.g., intervening cells 750 and 760) are selected.

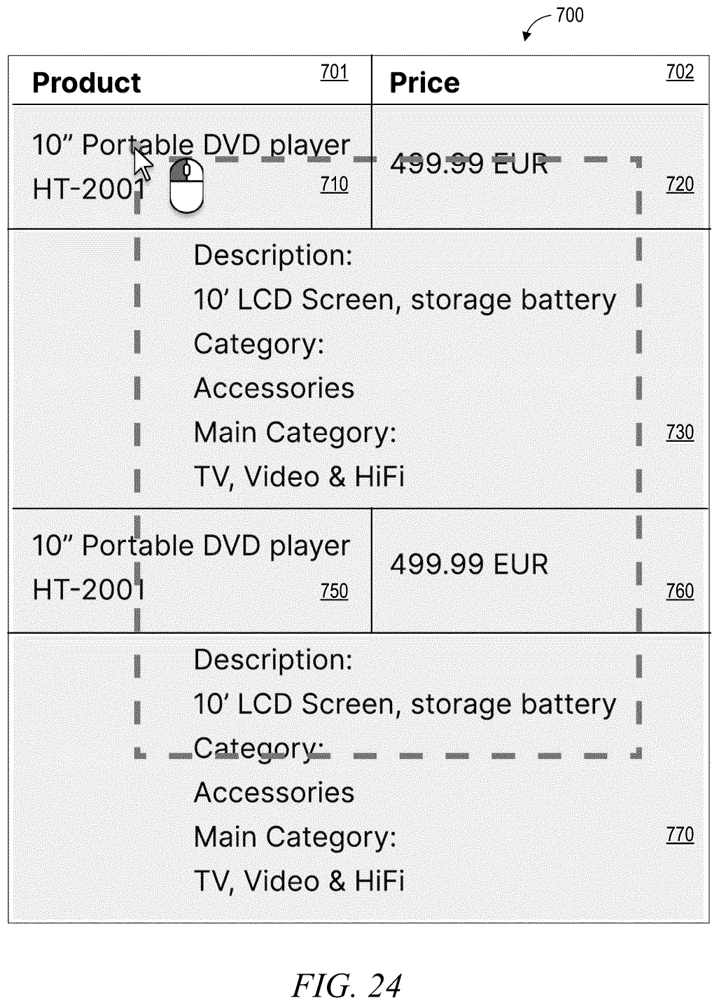

In FIG. 24, the cursor drag input has extended still further upward and continues to be indicated by the dark blue dashed rectangle. As indicated, the cursor drag input has extended still further upward to a cell (e.g., cell 710). The cursor drag input was generated by a left click on a mouse, as indicated by a red highlight on a mouse icon. The user interface 700 uses light blue highlights to indicate that four cells (e.g., cells 710, 720, 750, and 760) and two generated windows (e.g., generated windows 730 and 770) are selected (e.g., included in the selection of information). Since the cursor drag input started in a generated window, all generated windows whose data comes from non-shown cells in the same rows as selected cells are now selected.

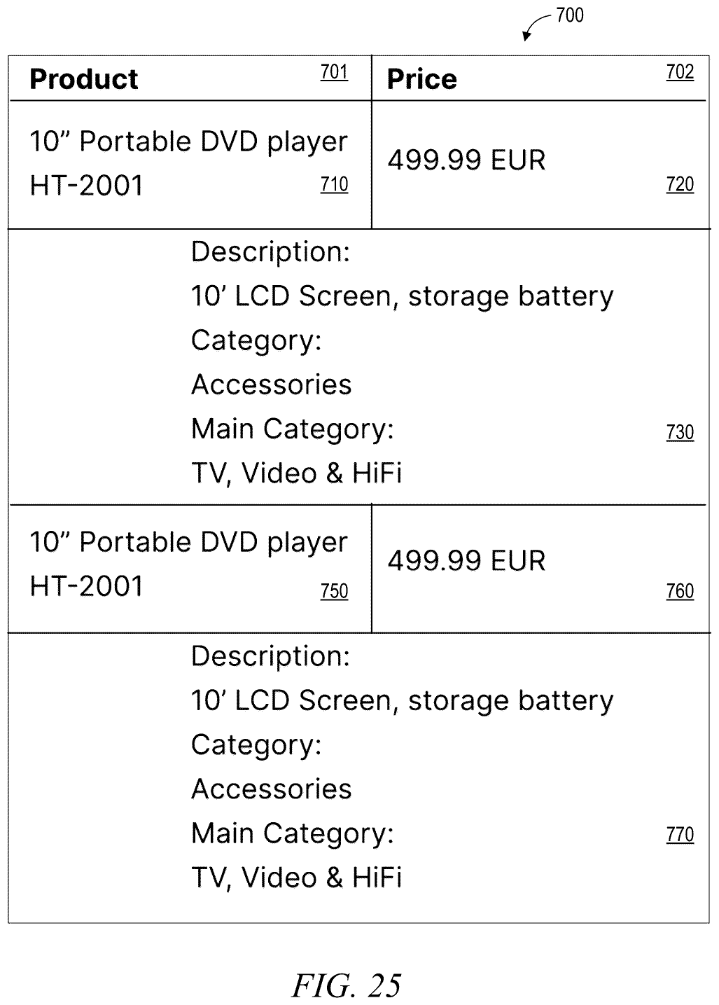

FIGS. 25-27 are user-interface screenshots illustrating sequential phases in selection of information by using a keyboard input that selects down and right, according to some example embodiments. The user interface 700 may be displayed (e.g., by the machine 110, the device 130, or both) with sequential visual appearances that correspond to such sequential phases.

In FIG. 25, the user interface 700 is in an initial state with an initial appearance, without any information selected. A user can use the arrow keys (e.g., UP, RIGHT, DOWN, and LEFT) to highlight and scroll through various rows and columns such that, once highlighted, the keyboard focus is on the cell most recently highlighted by the various arrow key operations.

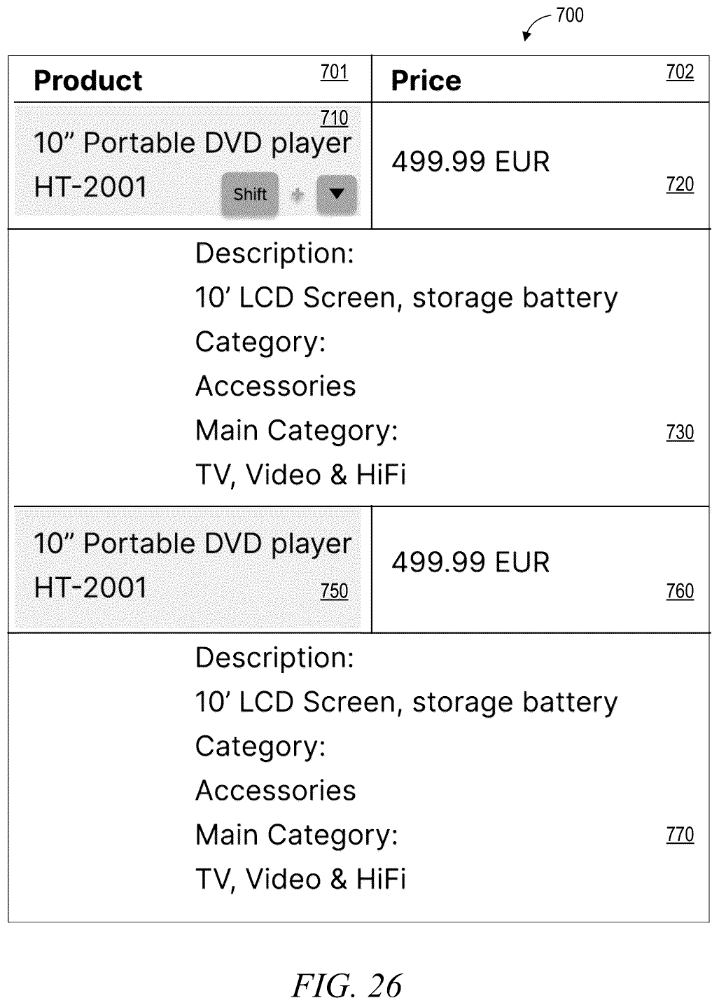

In FIG. 26, a keyboard input (e.g., SPACE, then SHIFT +ARROW DOWN) has selected one cell (e.g., cell 710) and then extended the resulting selection input downward to another cell (e.g., cell 750). The keyboard input included a key combination of SHIFT+ARROW DOWN, as indicated by orange key icons. The user interface 700 uses light blue highlights to indicate that the two cells (e.g., cells 710 and 750) are selected (e.g., included in the selection of information). Since the keyboard input did not start or stop on a generated window, no generated window is selected. Thus, only data from cells 710 and 750 is selected.

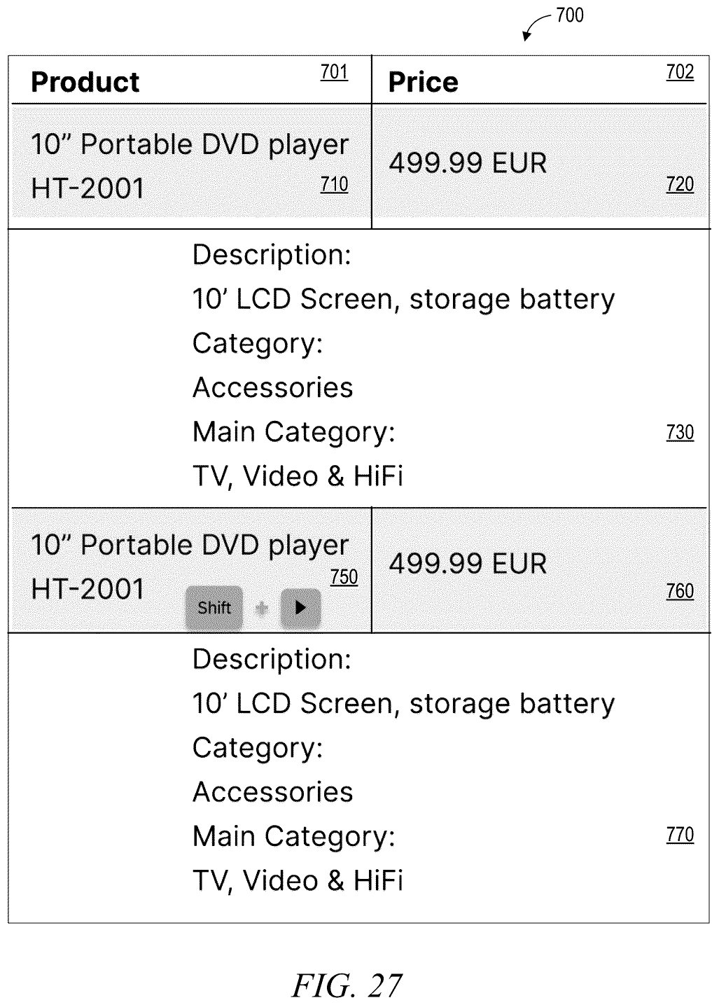

In FIG. 27, the keyboard input has extended the selection input to further cells (e.g., cells 720 and 760). The keyboard input included a key combination of SHIFT+ARROW RIGHT, as indicated by orange key icons. The user interface 700 uses light blue highlights to indicate that four cells (e.g., cells 710, 720, 750, and 760) are selected (e.g., included in the selection of information). Since the keyboard input did not start or stop on a generated window, no generated window is selected. Thus, only data from cells 710, 720, 750, and 760 is selected.

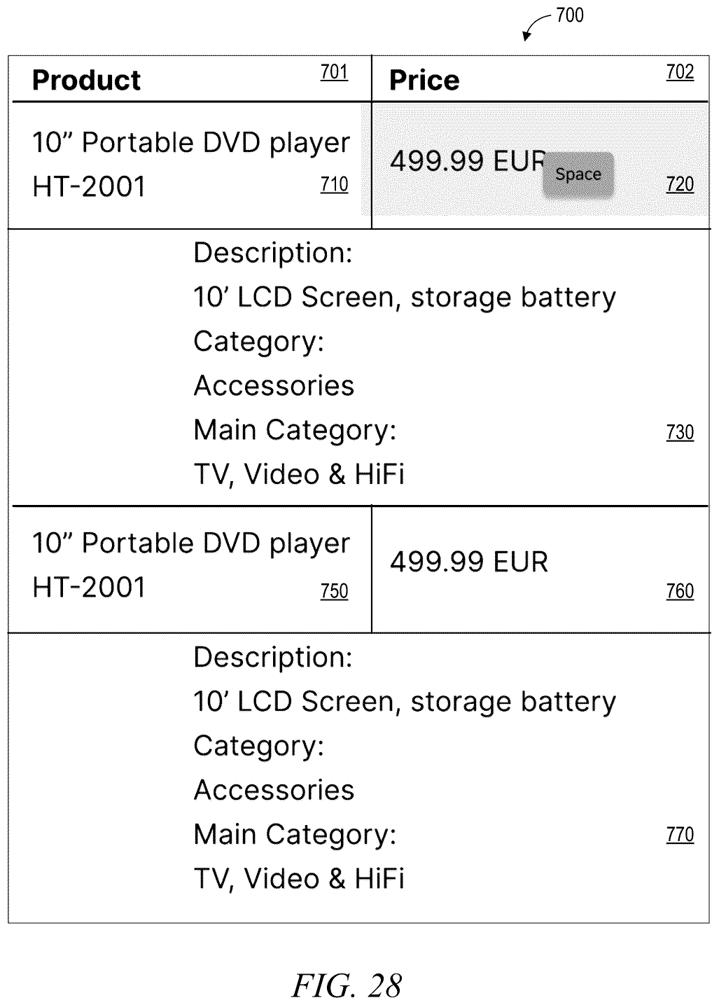

FIGS. 28-30 are user-interface screenshots illustrating sequential phases in selection of information by using a keyboard input that selects down and left, according to some example embodiments. The user interface 700 may be displayed (e.g., by the machine 110, the device 130, or both) with sequential visual appearances that correspond to such sequential phases.

In FIG. 28, a keyboard input (e.g., SPACE) has selected one cell (e.g., cell 720) and set the resulting selection input to that cell. The keyboard input included a SPACE keystroke, as indicated by an orange key icon. Since keyboard inputs do not actually take place inside the user interface 700, the location of the orange key icon has no significance in FIG. 28. The user interface 700 uses a light blue highlight to indicate that the cell (e.g., cell 720) is selected (e.g., included in the selection of information). Since the keyboard input did not start or stop on a generated window, no generated window is selected.

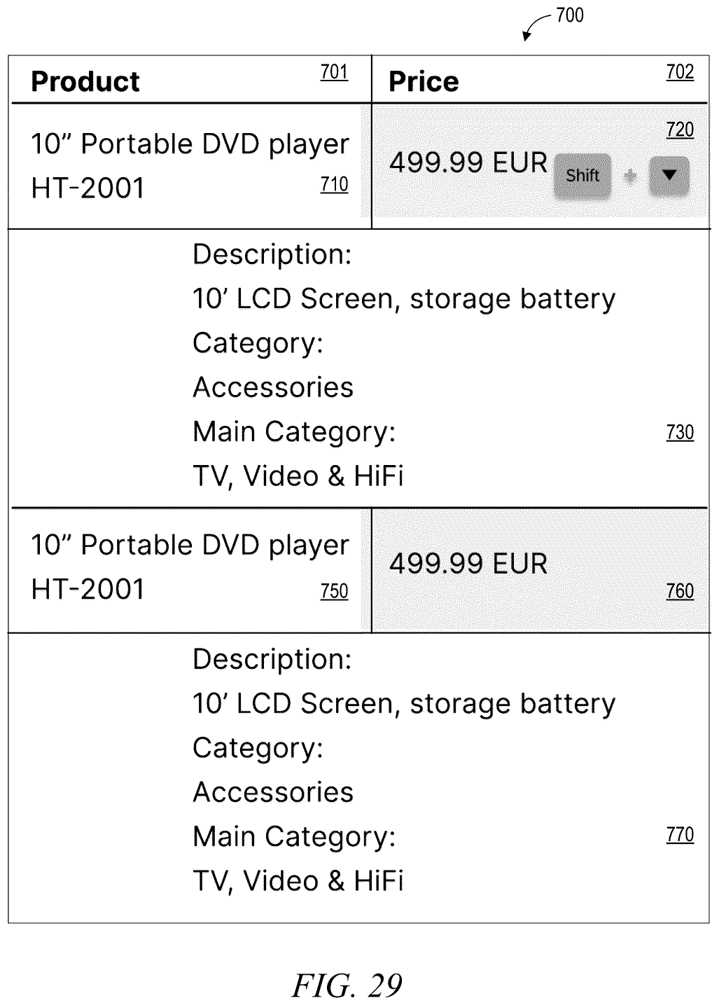

In FIG. 29, the keyboard input has extended the selection input to another cell (e.g., cell 760). The keyboard input included a key combination of SHIFT+ARROW DOWN, as indicated by orange key icons. Since keyboard inputs do not actually take place inside the user interface 700, the location of the orange key icons has no significance in FIG. 29. The user interface 700 uses light blue highlights to indicate that the two cells (e.g., cells 720 and 760) are selected (e.g., included in the selection of information). Since the keyboard input did not start or stop on a generated window, no generated window is selected.

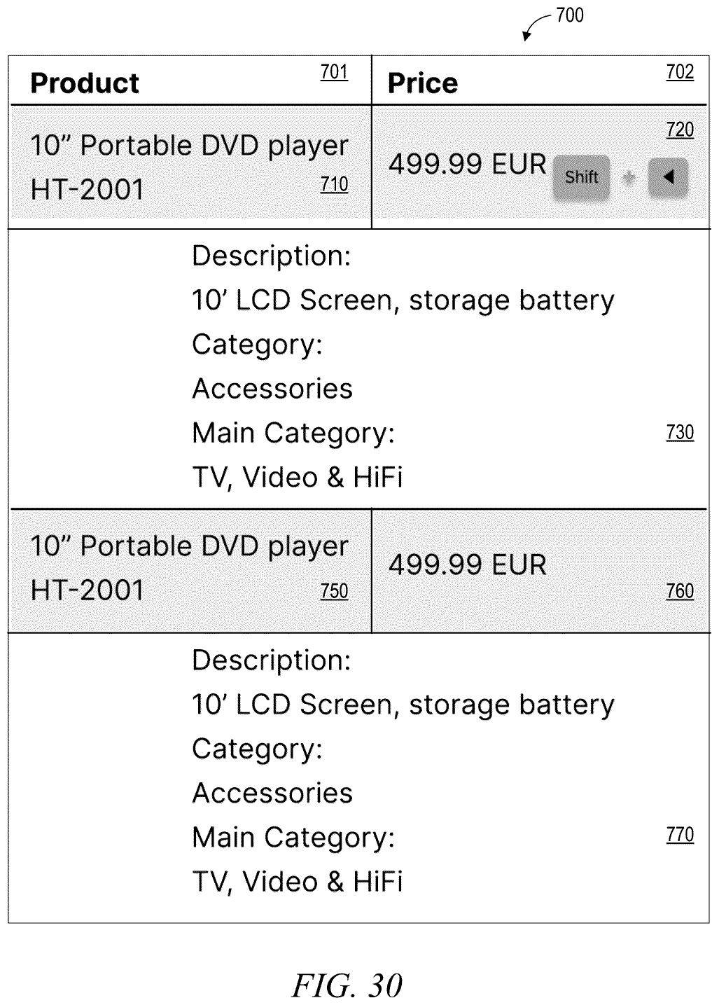

In FIG. 30, the keyboard input has extended the selection input leftward to further cells (e.g., cells 710 and 750). The keyboard input included a key combination of SHIFT+ARROW LEFT, as indicated by orange key icons. Since keyboard inputs do not actually take place inside the user interface 700, the location of the orange key icons has no significance in FIG. 30. The user interface 700 uses light blue highlights to indicate that four cells (e.g., cells 710, 720, 750, and 760) are selected (e.g., included in the selection of information). Since the keyboard input did not start or stop on a generated window, no generated window is selected.

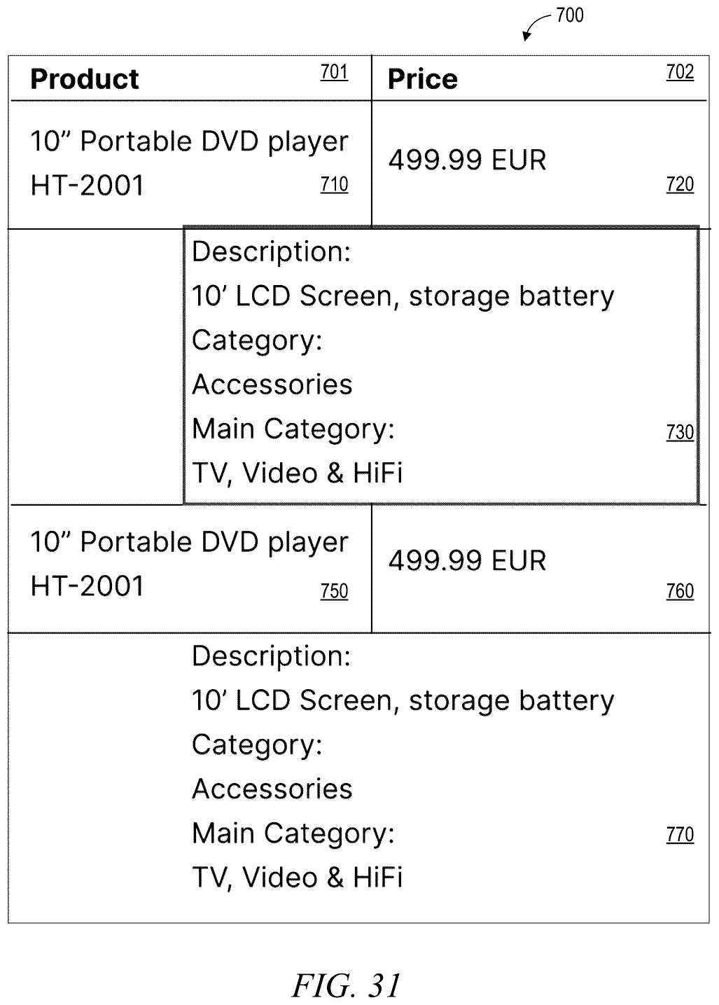

FIGS. 31-33 are user-interface screenshots illustrating sequential phases in selection of information by using a keyboard input that starts on a generated window, according to some example embodiments. The user interface 700 may be displayed (e.g., by the machine 110, the device 130, or both) with sequential visual appearances that correspond to such sequential phases.

In FIG. 31, the user interface 700 is in an initial state with an initial appearance, without any information selected, although a focus (e.g., cursor focus) of the user interface 700 is on a generated window (e.g., generated window 730), as indicated by a dark blue outline. For example, a user may have used one or more arrow keys (e.g., UP, RIGHT, DOWN, and LEFT) to traverse the various displayed rows and column such that the generated window 730 is focused upon at this point (e.g., before any selection of data is made).

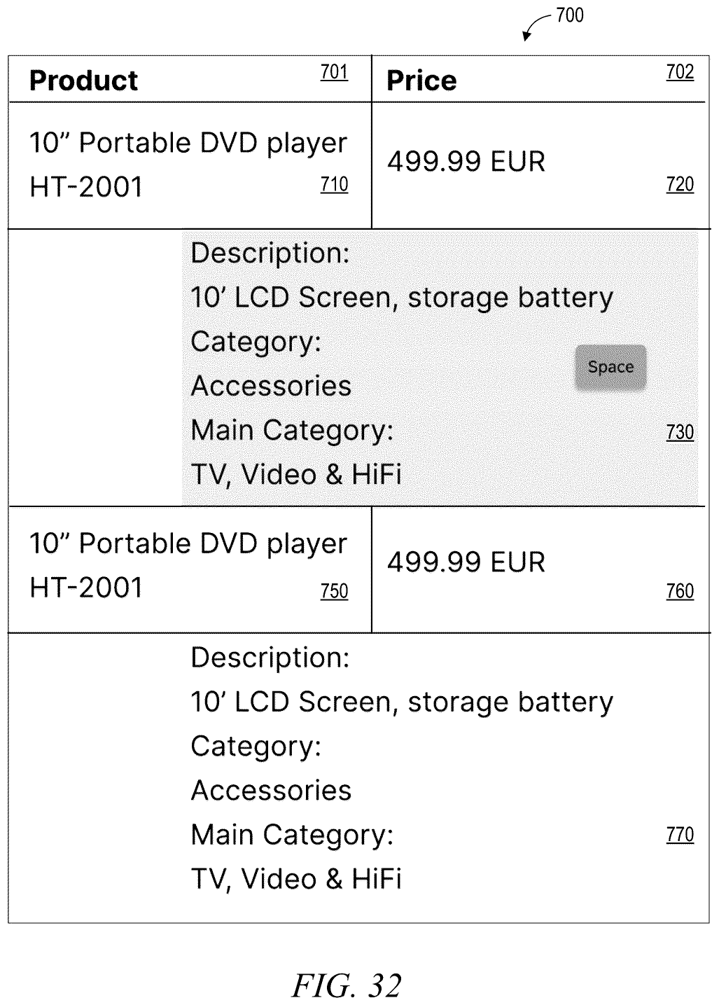

In FIG. 32, a keyboard input (e.g., SPACE) has selected the generated window (e.g., generated window 730), on which the focus has remained, and set the resulting selection input to that generated window. The keyboard input included a SPACE keystroke, as indicated by an orange key icon. The user interface 700 uses a light blue highlight to indicate that the generated window (e.g., generated window 730) is selected (e.g., included in the selection of information). Since the keyboard input started and stopped on a generated window, the generated window is now selected.

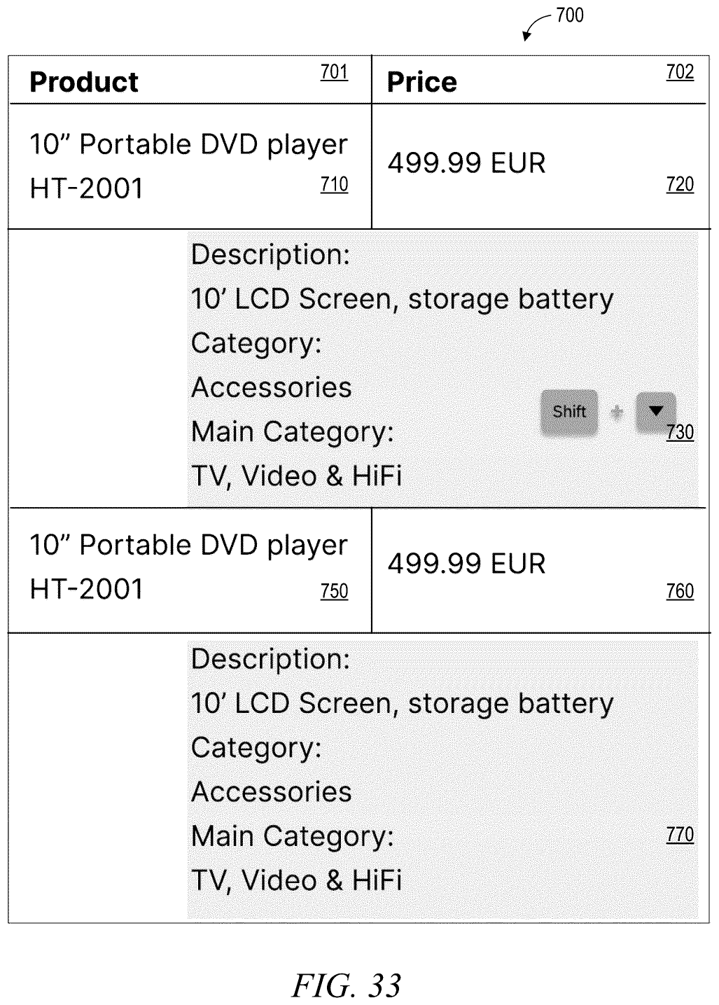

In FIG. 33, the keyboard input has extended the selection input downward to another generated window (e.g., generated window 770). The keyboard input included a key combination of SHIFT+ARROW DOWN, as indicated by orange key icons. The user interface 700 uses light blue highlights to indicate that the two generated windows (e.g., generated windows 730 and 770) are selected (e.g., included in the selection of information). Since the keyboard input started on one generated window and stopped on another generated window, the two generated windows and all generated windows between the two generated windows, in this case none, are now selected. Because the selection input started in a generated window (e.g., generated window 730), the only cells that can then be added for inclusion in the selection input are those displayed cells that are in the same row as the one or more non-displayed cells whose data (e.g., values) are shown in that same generated window (e.g., generated window 730). However, there are no such cells in this situation, and accordingly no cells (e.g., intervening cells 750 and 760) are selected.

According to various example embodiments, one or more of the methodologies described herein may facilitate information selection in a table with a generated window. Moreover, one or more of the methodologies described herein may facilitate quick, convenient, accurate, and precise selection of data from one or more displayed cells, one or more displayed generated windows, or any suitable combination thereof, consistent with the methodologies discussed herein. Hence, one or more of the methodologies described herein may facilitate data selection for further processing, such as copying and pasting of data displayed in one or more generated tables, including on relatively small display screens (e.g., on mobile devices, such as tablet computers or smartphones) where some information may be hidden, off-screen, cropped, truncated, or otherwise omitted from view, as well as performance of subsequent operations on such data, compared to capabilities of pre-existing systems and methods.

When these effects are considered in aggregate, one or more of the methodologies described herein may obviate a need for certain efforts or resources that otherwise would be involved in information selection in a table with a generated window. Efforts expended by a user in selecting information in a table with a generated window may be reduced by use of (e.g., reliance upon) a special-purpose machine that implements one or more of the methodologies described herein. As an example, the need for scrolling across multiple, non-visible columns or rows in order to select data for further processing may be avoided. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

The following enumerated descriptions describe various examples of methods, machine-readable media, and systems (e.g., machines, devices, or other apparatus) discussed herein. Any one or more features of an example, taken in isolation or combination, should be considered as being within the disclosure of this application.

A first example provides a method comprising:
accessing, by one or more processors, a table that includes cells arranged in columns and rows;
displaying, by the one or more processors, a first cell of the table, the displayed first cell being in a row that includes a second cell in a column not displayed;
generating and displaying, by the one or more processors, a window adjacent to the displayed first cell and showing data from the second cell not displayed;
detecting, by the one or more processors, a selection input that has a selection endpoint and defines a selection of information; and
by one or more processors and based on the selection endpoint of the selection input being within the window displayed adjacent to the first cell, indicating that the data from the second cell and shown in the window is included in the selection of information defined by the selection input.

A second example provides a method according to the first example, wherein:
the selection endpoint of the selection input is a selection starting point; and
the indicating that the data from the second cell and shown in the window is included in the selection is based on the selection starting point being within the window displayed adjacent to the first cell.

A third example provides a method according to the first example, wherein:
the selection endpoint of the selection input is a selection stopping point; and
the indicating that the data from the second cell and shown in the window is included in the selection is based on the selection stopping point being within the window displayed adjacent to the first cell.

A fourth example provides a method according to any of the first through third examples, wherein:
the selection endpoint of the selection input is defined by a cursor drag endpoint; and
the indicating that the data from the second cell and shown in the window is included in the selection is based on the cursor drag endpoint being within the window displayed adjacent to the first cell.

A fifth example provides a method according to any of the first through third examples, wherein:
the selection endpoint of the selection input is defined by a keyboard input; and
the indicating that the data from the second cell and shown in the window is included in the selection is based on the keyboard input corresponding to the window displayed adjacent to the first cell.

A sixth example provides a method according to any of the first through fifth examples, further comprising:
avoiding flicker of the window displayed adjacent to the first cell by performing a time delay between the selection endpoint entering the window and the indicating that the data from the second cell and shown in the window is included in the selection.

A seventh example provides a method according to any of the first through sixth examples, wherein:
the data from the second cell not displayed includes a value that quantifies a label of the column not displayed;
the window adjacent to the first cell shows the label of the column not displayed with the value from the second cell not displayed; and
the selection of information includes the value from the second cell not displayed but excludes the label of the column not displayed.

An eighth example provides a machine-readable medium (e.g., a non-transitory machine-readable medium) comprising instructions that, when executed by one or more processors of a machine, cause the machine to perform operations comprising:
accessing a table that includes cells arranged in columns and rows;
displaying a first cell of the table, the displayed first cell being in a row that includes a second cell in a column not displayed;
generating and displaying a window adjacent to the displayed first cell and showing data from the second cell not displayed;
detecting a selection input that has a selection endpoint and defines a selection of information; and
based on the selection endpoint of the selection input being within the window displayed adjacent to the first cell, indicating that the data from the second cell and shown in the window is included in the selection of information defined by the selection input.

A ninth example provides a machine-readable medium according to the eighth example, wherein:
the selection endpoint of the selection input is a selection starting point; and
the indicating that the data from the second cell and shown in the window is included in the selection is based on the selection starting point being within the window displayed adjacent to the first cell.

A tenth example provides machine-readable medium according to the eighth example, wherein:
the selection endpoint of the selection input is a selection stopping point; and
the indicating that the data from the second cell and shown in the window is included in the selection is based on the selection stopping point being within the window displayed adjacent to the first cell.

An eleventh example provides a machine-readable medium according to the eighth through tenth examples, wherein:
the selection endpoint of the selection input is defined by a cursor drag endpoint; and
the indicating that the data from the second cell and shown in the window is included in the selection is based on the cursor drag endpoint being within the window displayed adjacent to the first cell.

A twelfth example provides a machine-readable medium according to the eighth through tenth examples, wherein:
the selection endpoint of the selection input is defined by a keyboard input; and
the indicating that the data from the second cell and shown in the window is included in the selection is based on the keyboard input corresponding to the window displayed adjacent to the first cell.

A thirteenth example provides a machine-readable medium according to any of the eighth through twelfth examples, wherein the operations further comprise:
avoiding flicker of the window displayed adjacent to the first cell by performing a time delay between the selection endpoint entering the window and the indicating that the data from the second cell and shown in the window is included in the selection.

A fourteenth example provides a machine-readable medium according to any of the eighth through thirteenth examples, wherein:
the data from the second cell not displayed includes a value that quantifies a label of the column not displayed;
the window adjacent to the first cell shows the label of the column not displayed with the value from the second cell not displayed; and
the selection of information includes the value from the second cell not displayed but excludes the label of the column not displayed.

A fifteenth example provides a system (e.g., a computer system of one or more machines) comprising:
one or more processors; and
a memory storing instructions that, when executed by at least one processor among the one or more processors, cause the system to perform operations comprising:
accessing a table that includes cells arranged in columns and rows;
displaying a first cell of the table, the displayed first cell being in a row that includes a second cell in a column not displayed;
generating and displaying a window adjacent to the displayed first cell and showing data from the second cell not displayed;
detecting a selection input that has a selection endpoint and defines a selection of information; and
based on the selection endpoint of the selection input being within the window displayed adjacent to the first cell, indicating that the data from the second cell and shown in the window is included in the selection of information defined by the selection input.

A sixteenth example provides a system according to the fifteenth example, wherein:
the selection endpoint of the selection input is a selection starting point; and
the indicating that the data from the second cell and shown in the window is included in the selection is based on the selection starting point being within the window displayed adjacent to the first cell.

A seventeenth example provides a system according to the fifteenth example, wherein:
the selection endpoint of the selection input is a selection stopping point; and
the indicating that the data from the second cell and shown in the window is included in the selection is based on the selection stopping point being within the window displayed adjacent to the first cell.

An eighteenth example provides a system according to any of the fifteenth through seventeenth examples, wherein:
the selection endpoint of the selection input is defined by a cursor drag endpoint; and
the indicating that the data from the second cell and shown in the window is included in the selection is based on the cursor drag endpoint being within the window displayed adjacent to the first cell.

A nineteenth example provides a system according to any of the fifteenth through seventeenth examples, wherein:
the selection endpoint of the selection input is defined by a keyboard input; and
the indicating that the data from the second cell and shown in the window is included in the selection is based on the keyboard input corresponding to the window displayed adjacent to the first cell.

A twentieth example provides a system according to any of the fifteenth through nineteenth examples, wherein the operations further comprise:
avoiding flicker of the window displayed adjacent to the first cell by performing a time delay between the selection endpoint entering the window and the indicating that the data from the second cell and shown in the window is included in the selection.

A twenty-first example provides a carrier medium carrying machine-readable instructions for controlling a machine to carry out the operations (e.g., method operations) performed in any one of the previously described examples.

FIG. 34 is a block diagram illustrating components of a machine 3400, according to some example embodiments, able to read instructions 3424 from a machine-readable medium 3422 (e.g., a non-transitory machine-readable medium, a machine-readable storage medium, a computer-readable storage medium, or any suitable combination thereof) and perform any one or more of the methodologies discussed herein, in whole or in part. Specifically, FIG. 34 shows the machine 3400 in the example form of a computer system (e.g., a computer) within which the instructions 3424 (e.g., software, a program, an application, an applet, an app, or other executable code) for causing the machine 3400 to perform any one or more of the methodologies discussed herein may be executed, in whole or in part.

In alternative embodiments, the machine 3400 operates as a standalone device or may be communicatively coupled (e.g., networked) to other machines. In a networked deployment, the machine 3400 may operate in the capacity of a server machine or a client machine in a server-client network environment, or as a peer machine in a distributed (e.g., peer-to-peer) network environment. The machine 3400 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 3424, sequentially or otherwise, that specify actions to be taken by that machine. Further, while only a single machine is illustrated, the term “machine” shall also be taken to include any collection of machines that individually or jointly execute the instructions 3424 to perform all or part of any one or more of the methodologies discussed herein.

The machine 3400 includes a processor 3402 (e.g., one or more central processing units (CPUs), one or more graphics processing units (GPUs), one or more digital signal processors (DSPs), one or more application specific integrated circuits (ASICs), one or more radio-frequency integrated circuits (RFICs), one or more tensor processing units (TPUs), one or more neural processing units (NPUs), one or more vision processing units (VPUs), one or more machine-learning accelerators, one or more artificial-intelligence accelerators, one or more neuromorphic processors, one or more quantum processors, or any suitable combination thereof), a main memory 3404, and a static memory 3406, which are configured to communicate with each other via a bus 3408. The processor 3402 contains solid-state digital microcircuits (e.g., electronic, optical, biological, or any suitable combination thereof) that are configurable, temporarily or permanently, by some or all of the instructions 3424 such that the processor 3402 is configurable to perform any one or more of the methodologies described herein, in whole or in part. For example, a set of one or more microcircuits of the processor 3402 may be configurable to execute one or more modules (e.g., software modules) described herein.

In some example embodiments, the processor 3402 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Parallel processing on one or more multicore processors may be implemented via one or more suitable architectures, such as superscalar, very long instruction word (VLIW), vector processing, or single-instruction/multiple-data (SIMD), which allow each core to run separate instruction streams concurrently. A processor may be emulated in software, running on a physical processor, as a virtual processor or virtual circuit. The virtual processor may behave like an independent processor but is implemented in software rather than hardware. Although the beneficial effects described herein may be provided by the machine 3400 with at least the processor 3402, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 3400 may further include a graphics display 3410 (e.g., a plasma display panel (PDP), a light emitting diode (LED) display, a liquid crystal display (LCD), a projector, a cathode ray tube (CRT), or any other display capable of displaying graphics or video). The machine 3400 may also include an alphanumeric input device 3412 (e.g., a keyboard or keypad), a pointer input device 3414 (e.g., a mouse, a touchpad, a touchscreen, a trackball, a joystick, a stylus, a motion sensor, an eye tracking device, a data glove, or other pointing instrument), a data storage 3416, an audio generation device 3418 (e.g., a sound card, an amplifier, a speaker, a headphone jack, or any suitable combination thereof), and a network interface device 3420.

The data storage 3416 (e.g., a data storage device) includes the machine-readable medium 3422 (e.g., a tangible and non-transitory machine-readable storage medium) on which are stored the instructions 3424 embodying any one or more of the methodologies or functions described herein. The instructions 3424 may also reside, completely or at least partially, within the main memory 3404, within the static memory 3406, within the processor 3402 (e.g., within the processor's cache memory), or any suitable combination thereof, before or during execution thereof by the machine 3400. Accordingly, the main memory 3404, the static memory 3406, and the processor 3402 may be considered machine-readable media (e.g., tangible and non-transitory machine-readable media). The instructions 3424 may be transmitted or received over the network 190 via the network interface device 3420. For example, the network interface device 3420 may communicate the instructions 3424 using any one or more transfer protocols (e.g., hypertext transfer protocol (HTTP)).

In some example embodiments, the machine 3400 may be a portable computing device (e.g., a smart phone, a tablet computer, or a wearable device) and may have one or more additional input components 3430 (e.g., sensors or gauges). Examples of such input components 3430 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a temperature input component (e.g., a thermometer), and a gas detection component (e.g., a gas sensor). Input data gathered by any one or more of these input components 3430 may be accessible and available for use by any of the modules described herein (e.g., with suitable privacy notifications and protections, such as opt-in consent or opt-out consent, implemented in accordance with user preference, applicable regulations, or any suitable combination thereof).

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 3422 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of carrying (e.g., storing or communicating) the instructions 3424 for execution by the machine 3400, such that the instructions 3424, when executed by one or more processors of the machine 3400 (e.g., processor 3402), cause the machine 3400 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof.

A “non-transitory” machine-readable medium, as used herein, specifically excludes propagating signals per se. According to various example embodiments, the instructions 3424 for execution by the machine 3400 can be communicated via a carrier medium (e.g., a machine-readable carrier medium). Examples of such a carrier medium include a non-transient carrier medium (e.g., a non-transitory machine-readable storage medium, such as a solid-state memory that is physically movable from one place to another place) and a transient carrier medium (e.g., a carrier wave or other propagating signal that communicates the instructions 3424).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, by one or more processors, a table that includes cells arranged in columns and rows;
displaying, by the one or more processors, a first cell of the table, the displayed first cell being in a row that includes a second cell in a column not displayed;
generating and displaying, by the one or more processors, a window adjacent to the displayed first cell and showing data from the second cell not displayed;
detecting, by the one or more processors, a selection input that has a selection endpoint and defines a selection of information; and
by one or more processors and based on the selection endpoint of the selection input being within the window displayed adjacent to the first cell, indicating that the data from the second cell and shown in the window is included in the selection of information defined by the selection input.

2. The method of claim 1, wherein:
the selection endpoint of the selection input is a selection starting point; and
the indicating that the data from the second cell and shown in the window is included in the selection is based on the selection starting point being within the window displayed adjacent to the first cell.

3. The method of claim 1, wherein:
the selection endpoint of the selection input is a selection stopping point; and
the indicating that the data from the second cell and shown in the window is included in the selection is based on the selection stopping point being within the window displayed adjacent to the first cell.

4. The method of claim 1, wherein:
the selection endpoint of the selection input is defined by a cursor drag endpoint; and
the indicating that the data from the second cell and shown in the window is included in the selection is based on the cursor drag endpoint being within the window displayed adjacent to the first cell.

5. The method of claim 1, wherein:
the selection endpoint of the selection input is defined by a keyboard input; and
the indicating that the data from the second cell and shown in the window is included in the selection is based on the keyboard input corresponding to the window displayed adjacent to the first cell.

6. The method of claim 1, further comprising:
avoiding flicker of the window displayed adjacent to the first cell by performing a time delay between the selection endpoint entering the window and the indicating that the data from the second cell and shown in the window is included in the selection.

7. The method of claim 1, wherein:
the data from the second cell not displayed includes a value that quantifies a label of the column not displayed;
the window adjacent to the first cell shows the label of the column not displayed with the value from the second cell not displayed; and
the selection of information includes the value from the second cell not displayed but excludes the label of the column not displayed.

8. The method of claim 1, wherein:
a first selection endpoint of the selection input is a selection starting point within the window displayed adjacent to the first cell;
a second selection endpoint of the selection input is a selection stopping point within the window displayed adjacent to the first cell; and
the selection of information defined by the selection input includes only the data from the second cell and shown in the window without including any data from the first cell.

9. The method of claim 1, wherein:
a first selection endpoint of the selection input is a selection starting point within the first cell;
a second selection endpoint of the selection input is a selection stopping point within the window displayed adjacent to the first cell; and
the selection of information defined by the selection input includes the data from the second cell and shown in the window and includes further data from the first cell.

10. The method of claim 1, further comprising:
processing the selection of information that includes the data being shown in the window displayed adjacent to the first cell, the data being from the second cell not displayed.

11. The method of claim 10, wherein:
the processing of the selection information includes copying the data being shown in the window displayed adjacent to the first cell, the data being from the second cell not displayed.

12. A non-transitory machine-readable medium comprising instructions that, when executed by one or more processors of a machine, cause the machine to perform operations comprising:
accessing a table that includes cells arranged in columns and rows;
displaying a first cell of the table, the displayed first cell being in a row that includes a second cell in a column not displayed;
generating and displaying a window adjacent to the displayed first cell and showing data from the second cell not displayed;
detecting a selection input that has a selection endpoint and defines a selection of information; and
based on the selection endpoint of the selection input being within the window displayed adjacent to the first cell, indicating that the data from the second cell and shown in the window is included in the selection of information defined by the selection input.

13. The non-transitory machine-readable medium of claim 12, wherein:
the selection endpoint of the selection input is a selection starting point; and
the indicating that the data from the second cell and shown in the window is included in the selection is based on the selection starting point being within the window displayed adjacent to the first cell.

14. The non-transitory machine-readable medium of claim 12, wherein:
the selection endpoint of the selection input is a selection stopping point; and
the indicating that the data from the second cell and shown in the window is included in the selection is based on the selection stopping point being within the window displayed adjacent to the first cell.

15. The non-transitory machine-readable medium of claim 12, wherein:
the selection endpoint of the selection input is defined by a cursor drag endpoint; and
the indicating that the data from the second cell and shown in the window is included in the selection is based on the cursor drag endpoint being within the window displayed adjacent to the first cell.

16. A system comprising:
one or more processors; and
a memory storing instructions that, when executed by at least one processor among the one or more processors, cause the system to perform operations comprising:
accessing a table that includes cells arranged in columns and rows;
displaying a first cell of the table, the displayed first cell being in a row that includes a second cell in a column not displayed;
generating and displaying a window adjacent to the displayed first cell and showing data from the second cell not displayed;
detecting a selection input that has a selection endpoint and defines a selection of information; and
based on the selection endpoint of the selection input being within the window displayed adjacent to the first cell, indicating that the data from the second cell and shown in the window is included in the selection of information defined by the selection input.

17. The system of claim 16, wherein:
the selection endpoint of the selection input is a selection starting point; and
the indicating that the data from the second cell and shown in the window is included in the selection is based on the selection starting point being within the window displayed adjacent to the first cell.

18. The system of claim 16, wherein:
the selection endpoint of the selection input is a selection stopping point; and
the indicating that the data from the second cell and shown in the window is included in the selection is based on the selection stopping point being within the window displayed adjacent to the first cell.

19. The system of claim 16, wherein:
the selection endpoint of the selection input is defined by a cursor drag endpoint; and
the indicating that the data from the second cell and shown in the window is included in the selection is based on the cursor drag endpoint being within the window displayed adjacent to the first cell.

20. The system of claim 16, wherein the operations further comprise:
avoiding flicker of the window displayed adjacent to the first cell by performing a time delay between the selection endpoint entering the window and the indicating that the data from the second cell and shown in the window is included in the selection.
